(19) United States
(12) Patent Application Publication
(10) Pub. No.: US 2026/0075544 A1
(43) Pub. Date: Mar. 12, 2026

(54) RADIO FREQUENCY (RF) EXPOSURE COMPLIANCE BASED ON SPATIAL INFORMATION

(71) Applicant: QUALCOMM Incorporated, San Diego, CA (US)

(72) Inventors: Nandhini SRINIVASAN, San Diego, CA (US); Jagadish NADAKUDUTI, San Diego, CA (US); Lin LU, San Diego, CA (US)

(21) Appl. No.: 19/320,854

(22) Filed: Sep. 5, 2025

Related U.S. Application Data
(60) Provisional application No. 63/691,450, filed on Sep. 6, 2024.

(51) Int. Cl. H04W 52/32; H04L 5/00

(52) U.S. Cl. CPC H04W 52/325; H04L 5/0098

(57) ABSTRACT

Techniques and apparatus for radio frequency (RF) exposure compliance based on spatial information of RF exposure contributions among antennas of a wireless device are described. An example method generally includes accessing RF exposure contribution information associated with a plurality of antennas of the wireless device. At least one time-averaging operation is performed for at least a first antenna, based on the RF exposure contribution information. A transmit power limit is determined for the first antenna, based on the at least one time-averaging operation. A signal is transmitted from the first antenna at a transmission power level determined based at least in part on the transmit power limit in compliance with an RF exposure limit.

### CROSS-REFERENCE TO RELATED APPLICATION(S)

This application claims priority to and benefit of U.S. Provisional Patent Application No. 63/691,450, filed Sep. 6, 2024, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modem wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance.

Certain aspects of the subject matter described in this disclosure can be implemented in a method for wireless communication. The method generally includes accessing radio frequency (RF) exposure contribution information associated with a plurality of antennas of the wireless device. The RF exposure contribution information includes, for each antenna, a respective indication of RF exposure contribution from the antenna on one or more RF exposure contributors. The method also includes performing, for at least a first antenna of the plurality of antennas, at least one time-averaging operation, based on the RF exposure contribution information. The method also includes determining a first transmit power limit for the first antenna, based on the at least one time-averaging operation. The method further includes transmitting, from at least the first antenna, a first signal at a first transmission power level determined based at least in part on the first transmit power limit in compliance with an RF exposure limit.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to: access radio frequency (RF) exposure contribution information associated with a plurality of antennas of the wireless device, the RF exposure contribution information comprising, for each antenna, a respective indication of RF exposure contribution from the antenna on one or more RF exposure contributors; perform, for at least a first antenna of the plurality of antennas, at least one time-averaging operation, based on the RF exposure contribution information; determine a first transmit power limit for the first antenna, based on the at least one time-averaging operation; and transmit, from at least the first antenna, a first signal at a first transmission power level determined based at least in part on the first transmit power limit in compliance with an RF exposure limit.

Certain aspects of the subject matter described in this disclosure can be implemented in an apparatus for wireless communication. The apparatus generally includes means for accessing radio frequency (RF) exposure contribution information associated with a plurality of antennas of the wireless device. The RF exposure contribution information includes, for each antenna, a respective indication of RF exposure contribution from the antenna on one or more RF exposure contributors. The apparatus also includes means for performing, for at least a first antenna of the plurality of antennas, at least one time-averaging operation, based on the RF exposure contribution information. The apparatus also includes means for determining a first transmit power limit for the first antenna, based on the at least one time-averaging operation. The apparatus further includes means for transmitting, from at least the first antenna, a first signal at a first transmission power level determined based at least in part on the first transmit power limit in compliance with an RF exposure limit.

Certain aspects of the subject matter described in this disclosure can be implemented in a computer-readable medium. The computer-readable medium has instructions stored thereon for performing an operation. The operation includes accessing radio frequency (RF) exposure contribution information associated with a plurality of antennas of the wireless device. The RF exposure contribution information includes, for each antenna, a respective indication of RF exposure contribution from the antenna on one or more RF exposure contributors. The operation also includes performing, for at least a first antenna of the plurality of antennas, at least one time-averaging operation, based on the RF exposure contribution information. The operation also includes determining a first transmit power limit for the first antenna, based on the at least one time-averaging operation. The operation further includes transmitting, from at least the first antenna, a first signal at a first transmission power level determined based at least in part on the first transmit power limit in compliance with an RF exposure limit.

Certain aspects of the subject matter described in this disclosure can be implemented in a method for wireless communication. The method generally includes obtaining radio frequency (RF) exposure information associated with a plurality of antennas of a wireless device. The method also includes determining a respective set of RF exposure contributions for each antenna of the plurality of antennas, based on the RF exposure information, each RF exposure contribution of the set of RF exposure contributions being representative of a contribution of RF exposure from the antenna on another antenna of the plurality of antennas. The method further includes storing indications of the sets of RF exposure contributions.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to: obtain radio frequency (RF) exposure information associated with a plurality of antennas of a wireless device; determine a respective set of RF exposure contributions for each antenna of the plurality of antennas, based on the RF exposure information, each RF exposure contribution of the set of RF exposure contributions being representative of a contribution of RF exposure from the antenna on another antenna of the plurality of antennas; and store indications of the sets of RF exposure contributions.

Certain aspects of the subject matter described in this disclosure can be implemented in an apparatus for wireless communication. The apparatus generally includes means for obtaining radio frequency (RF) exposure information associated with a plurality of antennas of a wireless device. The apparatus also includes means for determining a respective set of RF exposure contributions for each antenna of the plurality of antennas, based on the RF exposure information, each RF exposure contribution of the set of RF exposure contributions being representative of a contribution of RF exposure from the antenna on another antenna of the plurality of antennas. The apparatus further includes means for storing indications of the sets of RF exposure contributions.

Certain aspects of the subject matter described in this disclosure can be implemented in a computer-readable medium. The computer-readable medium has instructions stored thereon for performing an operation. The operation includes obtaining radio frequency (RF) exposure information associated with a plurality of antennas of a wireless device. The operation also includes determining a respective set of RF exposure contributions for each antenna of the plurality of antennas, based on the RF exposure information, each RF exposure contribution of the set of RF exposure contributions being representative of a contribution of RF exposure from the antenna on another antenna of the plurality of antennas. The operation further includes storing indications of the sets of RF exposure contributions.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4 is a diagram illustrating an example system for measuring RF exposure values, in accordance with certain aspects of the present disclosure.

FIGS. 5A and 5B illustrate example data structures including an indication of RF exposure contribution information, in accordance with certain aspects of the present disclosure.

FIG. 6 is a flow diagram illustrating example operations for generating an RF exposure contribution information for an antenna, in accordance with certain aspects of the present disclosure.

FIG. 7 is a diagram illustrating the progression of generating the RF exposure contribution information, according to certain aspects of the present disclosure.

FIGS. 8A and 8B illustrate example data structures including an indication of RF exposure contribution information, in accordance with certain aspects of the present disclosure.

FIG. 9A illustrates composite RF exposure distributions for one or more antennas of a wireless device, in accordance with certain aspects of the present disclosure.

FIG. 9B illustrates a data structure including an indication of RF exposure contribution information for the composite RF exposure distributions illustrated in FIG. 9A, in accordance with certain aspects of the present disclosure.

FIG. 10 illustrates a data structure including RF exposure contribution information for antennas of a wireless device, in accordance with certain aspects of the present disclosure.

FIG. 11 illustrates another data structure including RF exposure contribution information for antennas of a wireless device, in accordance with certain aspects of the present disclosure.

FIG. 12 illustrates another data structure including RF exposure contribution information for antennas of a wireless device, in accordance with certain aspects of the present disclosure.

FIG. 13 illustrates an example workflow for a time-averaged RF exposure compliance evaluation based on RF exposure contribution information, in accordance with certain aspects of the present disclosure.

FIG. 14 illustrates another example workflow for a time-averaged RF exposure compliance evaluation based on RF exposure contribution information, in accordance with certain aspects of the present disclosure.

FIG. 15 is a flow diagram illustrating example operations for wireless communication by a wireless device, in accordance with certain aspects of the present disclosure.

FIG. 16 is a flow diagram illustrating example operations for wireless communication by a wireless device, in accordance with certain aspects of the present disclosure.

FIG. 17 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for radio frequency (RF) exposure compliance based on spatial information of RF exposure contributions among antennas of a wireless device.

In certain cases, a wireless device may evaluate RF exposure compliance using a two-dimensional (2D) RF exposure distribution (e.g., a specific absorption rate (SAR) distribution and/or power density (PD) distribution). The wireless device may perform a time-averaged RF exposure assessment over a given time window to determine a maximum allowable transmit power using the RF exposure distribution. In some cases, however, the RF exposure distribution may represent the maximum RF exposure exhibited by one or more antennas of the wireless device without regard to the spatial distribution of the RF exposure among the antennas.

In some RF exposure distributions, for example, all of the RF exposure hotspots (or peak RF exposures) from the antennas of the wireless device may be collocated. In such RF exposure distributions, each of the maximum RF exposures may correspond to the peak RF exposure across all of the surfaces of the wireless device, such that there is no distinction with respect to where the RF exposure is being emitted from the wireless device.

In other RF exposure distributions, all of the RF exposure hotspots (or peak RF exposures) from the antennas within an antenna group may be collocated. In such RF exposure distributions, each of the maximum RF exposures within an antenna group may correspond to the peak RF exposure across all antennas within the antenna group, such that there is no distinction with respect to where the RF exposure is being emitted from antennas within the antenna group. For example, the peak locations of RF exposure may not be at the same location for all antennas of an antenna group.

In certain scenarios, performing an RF exposure assessment (e.g., for time-averaged RF exposure compliance) over a given time window using an RF exposure distribution in which all antennas (or a subset of the antennas) of the wireless device are collocated may result in the wireless device determining and applying a conservative maximum allowable transmit power (e.g., unnecessarily low maximum allowable transmit power) during the time window. Such a conservative maximum allowable transmit power can affect the wireless communication performance of the wireless device in terms of reduced throughput, increased latency, reduced RF link quality, and decreased range, as illustrative examples.

Certain aspects of the present disclosure provide apparatus and methods for determining RF exposure contribution information associated with antennas of a wireless device, and performing a time-averaged RF exposure compliance evaluation using the RF exposure contribution information. As described in greater detail herein, the RF exposure contribution information may include, for each antenna, a respective indication of spatial contribution of RF exposure from the antenna on one or more RF exposure contributors. In some cases, the RF exposure contributor(s) may include each other antenna of the antennas of the wireless device. In other cases, the RF exposure contributor(s) may include one or more composite RF exposure maps for one or more antennas of the wireless device. In other cases, the RF exposure contributor(s) may include one or more regions of an RF exposure distribution (or map) for the wireless device. In yet other cases, the RF exposure contributor(s) may include one or more surfaces of the wireless device.

In certain aspects, the indications of spatial RF exposure contributions for each antenna may be represented with an RF exposure contribution matrix, which includes a respective contribution factor (or contribution ratio) corresponding to a level of interaction of RF exposure from the antenna on one of the RF exposure contributor(s).

In certain aspects, a wireless device may evaluate RF exposure compliance based on the RF exposure contribution information, e.g., as part of a time-averaged operation. For example, the wireless device may perform an RF exposure assessment of past RF exposure over a given time window using the RF exposure contribution information described herein to determine a maximum allowable transmit power for a future time interval in the time window. The time-averaged operation may track a normalized RF exposure history over the time window for each radio, and the wireless device may sum the normalized RF exposures of all active radios in simultaneous transmission scenarios. The sum of normalized RF exposure associated with the radios may use the respective RF exposure compliance information associated with each of the antenna(s) for the radios.

The apparatus and methods for determining RF exposure contribution information associated with antennas of a wireless device, and performing a time-averaged RF exposure compliance evaluation using the RF exposure contribution information may facilitate improved wireless communication performance in terms of improved signal quality at the receiver, higher throughput, decreased latency, and increased range, as illustrative examples. For example, the time-averaged RF exposure compliance evaluation based on the spatial information of RF exposure contributions among antennas may provide an accurate assessment of the RF exposure occurring at locations across the wireless device, allowing the wireless device to determine a higher maximum allowable transmit power limit for certain transmissions.

While aspects described herein refer to 2D distributions, it will be understood that the described operations and configurations may also be applied to three-dimensional (3D) maps or distributions.

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., radio frequency identification (RFID), wireless wide area network (WWAN), wireless local area network (WLAN), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN, each of the active component carriers used for wireless communications may be treated as a separate radio. Similarly, multi-band transmissions for Institute of Electrical and Electronics Engineers (IEEE) 802.11 may be treated as separate radios for each frequency band (e.g., 2.4 gigahertz (GHz), 5 GHz, and/or 6 GHz). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G New Radio (NR)) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers, and/or sections should not be limited by these terms. These terms may be only used to distinguish one device, element, component, region, layer, or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

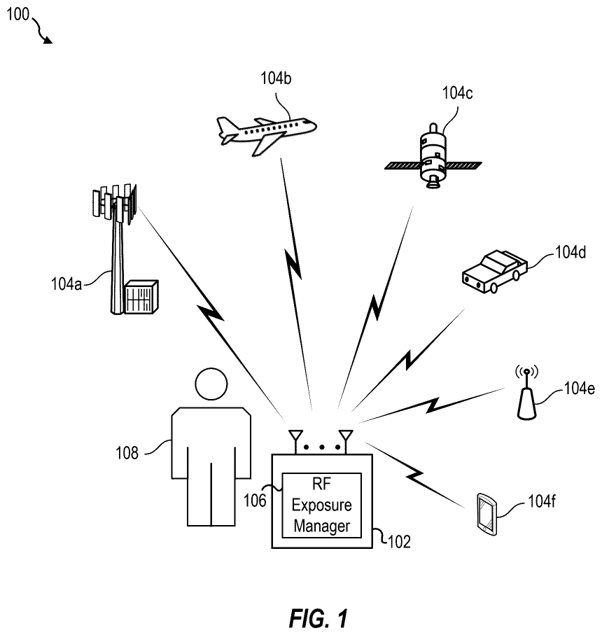

FIG. 1 illustrates an example wireless communication system 100 in which aspects of the present disclosure may be performed. For example, the wireless communication system 100 may include an RFID system, a WWAN, and/or a WLAN. For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a D2D communications network or a short-range communications system, such as Bluetooth communications.

As illustrated in FIG. 1, the wireless communication system 100 may include a wireless device 102 communicating with any of various wireless devices 104a-104f (a wireless device 104) via any of various RATs, where a wireless device may refer to a wireless communication device. The RATs may include, for example, RFID communications, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may be positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit. The RF exposure manager 106 may enforce RF exposure compliance (e.g., maintain time-averaged RF exposure compliance) using RF exposure contribution information described herein, in accordance with certain aspects of the present disclosure.

The wireless devices 104a-104f may include, for example, a base station 104a, an aircraft 104b, a satellite 104c, a vehicle 104d, an access point 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point (AP), base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as RFID, 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., RFID, 3G, 4G, 5G, 802.11a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., RFID, 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may additionally include bands in the 6,000 MHz and/or 7,000 MHz range in other examples.

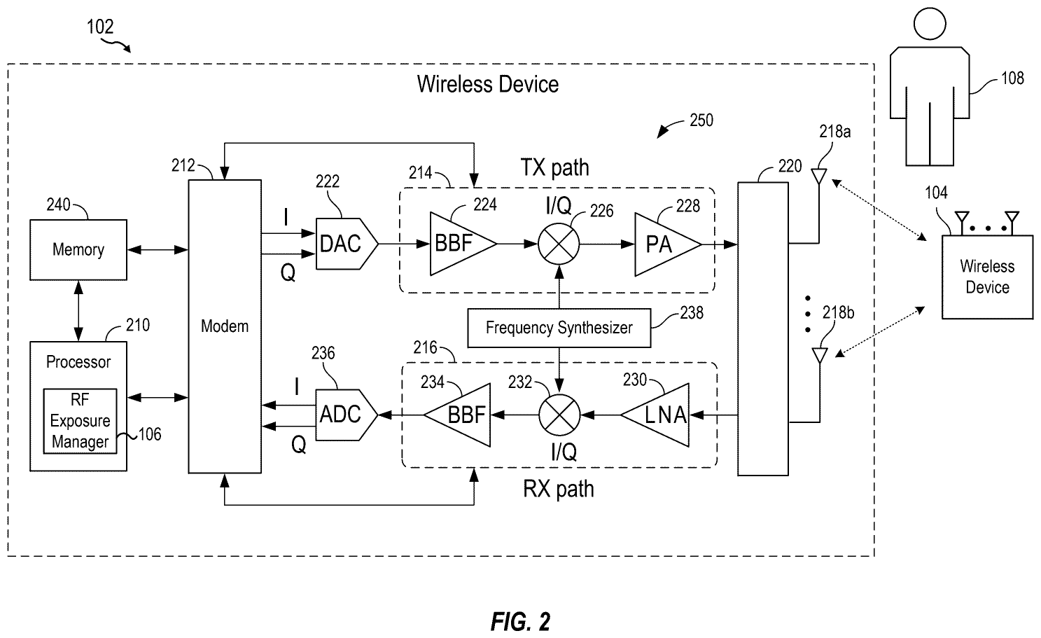

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package, or device that includes one or more modems 212. In some cases, the modem(s) 212 may include, for example, any of an RFID modem (e.g., a modem configured to communicate via RFID), a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem, the RFID modem, and/or the Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC) circuitry, a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via a first antenna 218a, and a second signal may be transmitted via a second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for in-phase and quadrature (I/Q) imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program code (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may enforce RF exposure compliance (e.g., maintain time-averaged RF exposure compliance) using RF exposure contribution information described herein, in accordance with certain aspects of the present disclosure.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposures

As noted, RF exposure may be expressed in terms of SAR and/or PD. As also noted, a wireless device (e.g., the wireless device 102) may be capable of transmitting signals using multiple wireless communication technologies. For example, the wireless device may transmit signals using a first wireless communication technology (e.g., 3G, 4G, 5G in sub-6 GHz bands, IEEE 802.11ac, etc.) in which RF exposure may be measured in terms of SAR, and a second wireless communication technology (e.g., 5G in 24 to 71 GHz bands, IEEE 802.11ad, IEEE 802.11ay, etc.) in which RF exposure may be measured in terms of PD.

To assess RF exposure from transmissions using the first technology (e.g., RFID, 3G, 4G, 5G in sub-6 GHz bands, IEEE 802.11ac, etc.), the wireless device may include multiple SAR values and/or distributions for the first technology stored in memory (e.g., memory 240 of FIG. 2). Each of the SAR values and/or distributions may correspond to a respective one of multiple transmit scenarios supported by the wireless device for the first technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings (or antenna groups), antenna configurations, single-input, single-output (SISO) or multiple-input, multiple-output (MIMO) transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions), as discussed further below. In some examples, the stored SAR value and/or distribution includes a single value (e.g., a peak value determined based on the description below, or a sum of peak values).

The SAR values and/or distribution (also referred to as a SAR map) for each transmit scenario may be generated based on measurements (e.g., E-field measurements) performed in a test laboratory using a model of a human body. After generation, the SAR values and/or distributions are stored in the memory to enable a processor (e.g., processor 210 of FIG. 2) to assess RF exposure in real time, as discussed further below. Each SAR distribution may include a set of SAR values, where each SAR value may correspond to a different location (e.g., on the model of the human body). Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or distribution for any transmission power level by multiplying each SAR value (e.g., in the SAR distribution) by the following transmission power scaler:

$$\frac{{Tx}_{c}}{{Tx}_{SAR}} \qquad ( 1 )$$

where Tx_{c} is a current transmission power level for the respective transmit scenario, and Tx_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a parameter indicating SISO transmission or MIMO transmission, a parameter indicating a set of operating conditions, a frequency band parameter indicating one or more frequency bands used for transmission (e.g., active frequency bands), a channel parameter indicating one or more channels used for transmission (e.g., active channels), a body position parameter (e.g., a device state index (DSI)) indicating the location of the wireless communication device relative to the user's body location (head, trunk, away from the body, etc.), exposure category, a parameter indicating at least one physical configuration of the wireless communication device, a parameter indicating a geographical location or region (e.g., public land mobile network (PLMN) code and/or a mobile country code (MCC)), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or distributions for the subset of transmit scenarios. In this example, the SAR values and/or distributions for each of the remaining transmit scenarios may be generated by combining two or more of the SAR values and/or distributions for the subset of transmit scenarios, as discussed further below.

For example, SAR measurements may be performed for each one of the antennas to generate a SAR value or distribution for each one of the antennas. In this example, a SAR value or distribution for a transmit scenario in which two or more of the antennas are active may be generated by combining the SAR values or distributions for the two or more active antennas.

In another example, SAR measurements may be performed for each one of multiple frequency bands to generate a SAR value or distribution for each one of the multiple frequency bands. In this example, a SAR value or distribution for a transmit scenario in which two or more frequency bands are active may be generated by combining the SAR values or distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit.

In certain aspects, the normalized SAR value or distribution for a transmit scenario may be generated by combining two or more normalized values or SAR distributions. For example, a normalized SAR value or distribution for a transmit scenario in which two or more antennas are active may be generated by combining the normalized SAR values or distributions for the two or more active antennas. For the case in which different transmission power levels are used for the active antennas, the normalized SAR value or distribution for each active antenna may be scaled by the respective transmission power level before combining the normalized SAR values or distributions for the active antennas. The normalized SAR value or distribution for simultaneous transmission from multiple active antennas may be given by the following:

$${SAR}_{norm \_ combined} = {\sum }_{i = 1}^{i = K} \frac{{Tx}_{i}}{{Tx}_{SARi}} \cdot \frac{{SAR}_{i}}{{SAR}_{lim}} \qquad ( 2 )$$

where SARₗᵢₘ is a SAR limit, SAR_{norm_combined} is the combined normalized SAR value or distribution for simultaneous transmission from the active antennas, i is an index for the active antennas, SARᵢ is the SAR value or distribution for the i^{th} active antenna, Txᵢ is the transmission power level for the i^{th} active antenna, Tx_{SARi} is the transmission power level for the SAR distribution for the i^{th} active antenna, and K is the number of the active antennas.

Equation (2) may be rewritten as follows:

$${SAR}_{norm \_ combined} = {\sum }_{i = 1}^{i = K} \frac{{Tx}_{i}}{{Tx}_{SARi}} \cdot {SAR}_{norm \_ i} \qquad ( 3 a )$$

where SAR_{norm_i} is the normalized SAR value or distribution for the i^{th} active antenna. In the case of simultaneous transmissions using multiple active antennas at the same transmitting frequency (e.g., MIMO), the combined normalized SAR value or distribution may be obtained by summing the square root of the individual normalized SAR values or distributions and computing the square of the sum, as given by the following:

$${SAR}_{norm \_ combined \_ MIMO} = {[ {\sum }_{i = 1}^{i = K} \sqrt{\frac{{Tx}_{i}}{{Tx}_{SARi}} \cdot {SAR}_{norm \_ i}} ]}^{2} . \qquad ( 3 b )$$

In another example, normalized SAR values or distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or distribution for each of the active frequency bands may be scaled by the respective transmission power level before combining the normalized SAR values or distributions for the active frequency bands. In this example, the combined SAR value or distribution may also be computed using Equation (3a) in which i is an index for the active frequency bands, SAR_{norm_i} is the normalized SAR value or distribution for the i^{th} active frequency band, Txᵢ is the transmission power level for the i^{th} active frequency band, and Tx_{SARi} is the transmission power level for the normalized SAR value or distribution for the i^{th} active frequency band.

To assess RF exposure from transmissions using the second technology (e.g., 5G in 24 to 60 GHz bands, IEEE 802.11ad, 802.11ay, etc.), the wireless device may include multiple PD values and/or distributions for the second technology stored in the memory (e.g., memory 240 of FIG. 2). Each of the PD values or distributions may correspond to a respective one of multiple transmit scenarios supported by the wireless device for the second technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings, antenna configurations, SISO or MIMO transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions), as discussed further below. In some examples, the stored PD value and/or distribution includes a single value (e.g., a peak value determined based on the description below, or a sum of peak values).

The PD values and/or distribution (also referred to as PD map) for each transmit scenario may be generated based on measurements (e.g., E-field measurements) performed in a test laboratory using a model of a human body. After generation, the PD values and/or distributions are stored in the memory to enable the processor (e.g., processor 210 of FIG. 2) to assess RF exposure in real time, as discussed further below. Each PD distribution may include a set of PD values, where each PD value may correspond to a different location (e.g., on the model of the human body).

The PD values in each PD distribution correspond to a particular transmission power level (e.g., the transmission power level at which the PD values were measured in the test laboratory). Since PD scales with transmission power level, the processor may scale a PD value or distribution for any transmission power level by multiplying each PD value (e.g., in the PD distribution) by the following transmission power scaler:

$$\frac{{Tx}_{c}}{{Tx}_{PD}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a parameter indicating SISO transmission or MIMO transmission, a parameter indicating a set of operating conditions, a frequency band parameter indicating one or more frequency bands used for transmission (e.g., active frequency bands), a channel parameter indicating one or more channels used for transmission (e.g., active channels), a body position parameter (e.g., a DSI) indicating the location of the wireless communication device relative to the user's body location (head, trunk, away from the body, etc.), exposure category, a parameter indicating at least one physical configuration of the wireless communication device, a parameter indicating a geographical location or region (e.g., PLMN code and/or a MCC), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or distributions for the subset of transmit scenarios. In this example, the PD values and/or distributions for each of the remaining transmit scenarios may be generated by combining two or more of the PD values and/or distributions for the subset of transmit scenarios, as discussed further below.

For example, PD measurements may be performed for each one of the antennas to generate a PD value or distribution for each one of the antennas. In this example, a PD value or distribution for a transmit scenario in which two or more of the antennas are active may be generated by combining the PD values or distributions for the two or more active antennas.

In another example, PD measurements may be performed for each one of multiple frequency bands to generate a PD value or distribution for each one of the multiple frequency bands. In this example, a PD value or distribution for a transmit scenario in which two or more frequency bands are active may be generated by combining the PD values or distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or distribution for a transmit scenario may be generated by combining two or more normalized PD values or distributions. For example, a normalized PD value or distribution for a transmit scenario in which two or more antennas are active may be generated by combining the normalized PD values or distributions for the two or more active antennas. For the case in which different transmission power levels are used for the active antennas, the normalized PD value or distribution for each active antenna may be scaled by the respective transmission power level before combining the normalized PD values or distributions for the active antennas. The normalized PD value or distribution for simultaneous transmission from multiple active antennas may be given by the following:

$${PD}_{norm \_ combined} = {\sum }_{i = 1}^{i = L} \frac{{Tx}_{i}}{{Tx}_{P D i}} \cdot \frac{{PD}_{i}}{{PD}_{lim}} \qquad ( 5 )$$

where PDₗᵢₘ is a PD limit, PD_{norm_combined} is the combined normalized PD value or distribution for simultaneous transmission from the active antennas, i is an index for the active antennas, PDi is the PD value or distribution for the i^{th} active antenna, Txᵢ is the transmission power level for the i^{th} active antenna, Tx_{PDi} is the transmission power level for the PD distribution for the i^{th} active antenna, and L is the number of the active antennas.

Equation (5) may be rewritten as follows:

$${PD}_{norm \_ combined} = {\sum }_{i = 1}^{i = L} \frac{{Tx}_{i}}{{Tx}_{PDi}} \cdot {PD}_{norm \_ i} \qquad ( 6 a )$$

where PD_{norm_i} is the normalized PD value or distribution for the i^{th} active antenna. In the case of simultaneous transmissions using multiple active antennas at the same transmitting frequency (e.g., MIMO), the combined normalized PD value or distribution may be obtained by summing the square root of the individual normalized PD values or distributions and computing the square of the sum, as given by the following:

$${PD}_{norm \_ combined \_ MIMO} = {[ {\sum }_{i = 1}^{i = K} \sqrt{\frac{{Tx}_{i}}{{Tx}_{SARi}} \cdot {PD}_{norm \_ i}} ]}^{2} . \qquad ( 6 b )$$

In another example, normalized PD values or distributions for different frequency bands may be stored in the memory. In this example, a normalized PD value or distribution for a transmit scenario in which two or more frequency bands are active may be generated by combining the normalized PD distributions for the two or more active frequency bands. For the case where the transmission power levels are different for the active frequency bands, the normalized PD value or distribution for each of the active frequency bands may be scaled by the respective transmission power level before combining the normalized PD values or distributions for the active frequency bands. In this example, the combined PD value or distribution may also be computed using Equation (6a) in which i is an index for the active frequency bands, PD_{norm_i} is the normalized PD value or distribution for the i^{th} active frequency band, Txᵢ is the transmission power level for the i^{th} active frequency band, and Tx_{PDi} is the transmission power level for the normalized PD value or distribution for the i^{th} active frequency band.

### Example RF Exposure Compliance

In certain cases, compliance with an RF exposure limit may be performed as a time-averaged RF exposure compliance evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

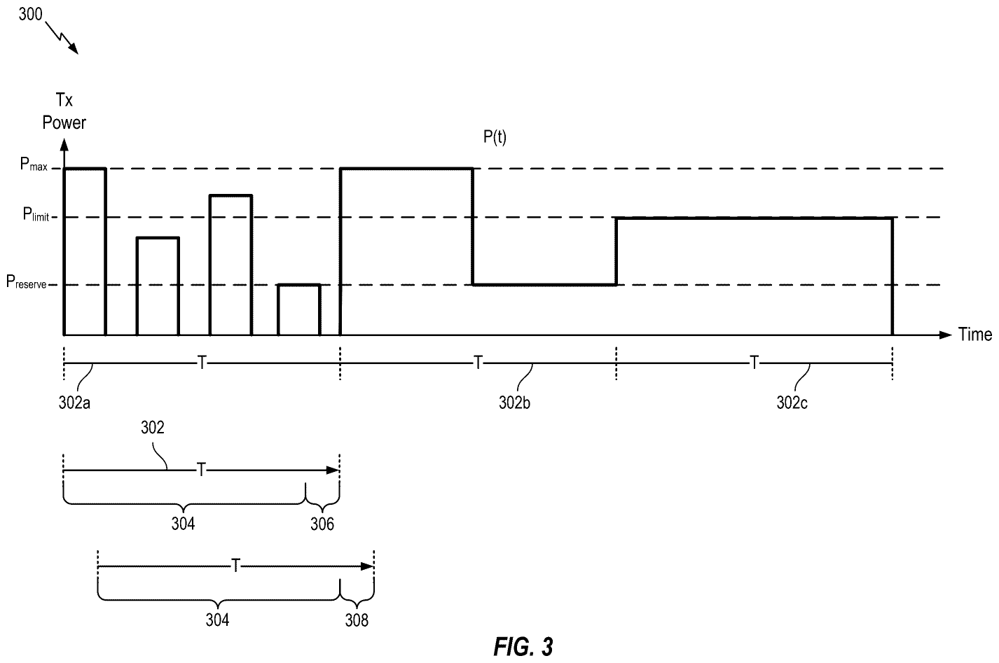

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-averaged mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure compliance evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example RF Exposure Measurements

In certain cases, the RF exposure of a wireless device may be certified with a regulatory agency (e.g., the FCC for the United States or the Innovation, Science and Economic Development Canada (ISED) for Canada). Spatial measurements may be taken with respect to a model (phantom) representing the human body, where the model may be filled with a liquid simulating human tissue. As discussed above, the first wireless device 102 may simultaneously transmit signals using the first technology (e.g., RFID, 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

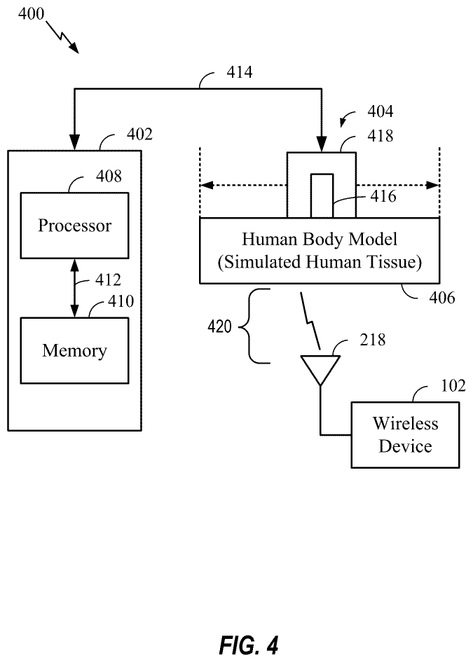

FIG. 4 is a diagram illustrating an example system 400 for measuring RF exposure levels (e.g., values and/or distributions) associated with a wireless communication device (e.g., the wireless device 102). As shown, the RF exposure measurement system 400 includes a processing system 402, a (robotic) RF probe 404, and a human body model 406. The RF exposure measurement system 400 may take RF measurements at various transmit scenarios. As used herein, a transmit scenario may correspond to various combinations of radios, communication technologies, antennas, antenna configurations, SISO or MIMO transmissions, operating conditions (or modes), frequency bands, RF exposure scenarios (e.g., head exposure, body-worn exposure, extremity (hand) exposure, and/or hotspot exposure), device use-case scenarios, physical configurations of a device, and/or geographical locations or regions associated with the wireless device 102. In some examples, these measurements may be used to generate an RF exposure map and determine suitable transmit power limits for the transmit powers of the antenna(s) 218 in compliance with one or more RF exposure limits, as further described herein. The wireless device 102 may emit electromagnetic radiation via the antenna(s) 218 at various transmit powers, and the RF exposure measurement system 400 may take RF measurements via the robotic RF probe 404 (e.g., to determine RF exposure map(s) for the antenna(s) 218). Transmit power limits (e.g., Pₗᵢₘᵢₜ) for the various transmit scenarios associated with the wireless device 102 may be determined based on the RF measurements and/or exposure maps. Note that while measurements are described as being performed with respect to the wireless device 102, measurements may be taken with respect to a (different) representative device (e.g., a sample device for testing purposes), and then transmit power limits loaded into or otherwise provided or conveyed to the wireless device 102 (e.g., the devices manufactured for end-users).

In some cases, a test separation distance 420 (or spacing) may be adjusted (increased or decreased) depending on the transmit scenario, where the test separation distance 420 may be the distance between a radiating structure (e.g., the antenna(s) 218) and any part of the human body, in this example, the human body model 406. For example, the test separation distance 420 may be set to 15 millimeters (mm) for body-worn exposure, 0 mm for head exposure, 10 mm for a hotspot exposure, etc. In certain cases, the test separation distance 420 may differ among regions. For example, the test separation distance 420 may be set to 0 mm for body-worn exposure for a particular region, whereas the test separation distance 420 may be set to 15 mm for body-worn exposure for another region, and in some cases, using the same RF exposure limit (e.g., 1.6 W/kg averaged over 1 gram). As the test separation distance 420 may differ among some regions, the corresponding transmit power limits (e.g., Pₗᵢₘᵢₜ) may differ among these regions regardless of whether the same RF exposure limit is applied.

The processing system 402 may include a processor 408 coupled to a memory 410 via a bus 412. The processing system 402 may be a computational device such as a computer. The processor 408 may include a microprocessor, a central processing unit (CPU), a graphics processing unit (GPU), a neural networks processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 408 may be in communication with the robotic RF probe 404 via an interface 414 (such as a computer bus interface), such that the processor 408 may obtain RF measurements taken by the robotic RF probe 404 and control the position of the robotic RF probe 404 relative to the human body model 406, for example.

The memory 410 may be configured to store instructions (e.g., computer-executable code) that when executed by the processor 408, cause the processor 408 to perform various operations. For example, the memory 410 may store instructions for obtaining the RF exposure values or distributions associated with various RF exposure/transmit scenarios and/or adjusting the position of the robotic RF probe 404.

The robotic RF probe 404 may include an RF probe 416 coupled to a robotic arm 418. In some aspects, the RF probe 416 may be a dosimetric probe capable of measuring RF exposures at various frequencies such as sub-6 GHz bands and/or mmWave bands. The RF probe 416 may be positioned by the robotic arm 418 in various locations (as indicated by the dotted arrows) to capture the electromagnetic radiation emitted by the antenna(s) 218 of the first wireless device 102. The robotic arm 418 may be a six-axis robot capable of performing precise movements to position the RF probe 416 to the location (on the human body model 406) of maximum electromagnetic field generated by the wireless device 102. In other words, the robotic arm 418 may provide six degrees of freedom in positioning the RF probe 416 with respect to the antenna(s) 218 of the wireless device 102 and/or the human body model 406.

The human body model 406 may be a specific anthropomorphic mannequin with simulated human tissue. For example, the human body model 406 may include one or more liquids that simulate the human tissue of the head, body, and/or extremities. The human body model 406 may simulate the human tissue for determining the maximum permissible transmission power of the antenna(s) 218 in compliance with various RF exposure limits implemented in various regions.

In certain aspects, the RF exposure levels associated with the wireless device 102 may be measured without the human body model 406. For example, the RF probe 416 may be an electric- or magnetic-field probe capable of estimating the SAR and/or PD exposure encountered by human tissue in the free-space surrounding the wireless device 102. While the example depicted in FIG. 4 is described herein with respect to obtaining RF exposure levels with a robotic RF probe to facilitate understanding, aspects of the present disclosure may also be applied to other suitable RF probe architectures, such as using multiple stationary RF probes positioned at various locations along the human body model 406 or free-space.

For a wireless device, a particular Pₗᵢₘᵢₜ may be defined per RAT, frequency band (or carrier, channel, etc.), antenna (or antenna group), antenna configuration, and/or RF exposure scenario (e.g., head exposure, body-worn exposure, hand exposure, hotspot exposure, etc.) (collectively referred to herein as a “transmit scenario”). In some cases, the RF exposure scenario may correspond to a DSI or a particular operational state of the device, where the DSI may indicate the device position relative to a human body, e.g., head, hand, body, etc. In certain cases, Pₗᵢₘᵢₜ may correspond to a particular RF exposure design target (e.g., SAR or PD), where a separate Pₗᵢₘᵢₜ may be determined for each RF exposure distribution (or, more generally, each transmit scenario), for example, as described herein with respect to FIG. 4. As an example, Pₗᵢₘᵢₜₖ for the k^{th} RF exposure distribution may be given by:

$${P}_{limitk} = {Tx}_{k} * RF\_exposure \_design \_target / max ( RF . {exp}_{k} ) \qquad ( 7 )$$

where max(RF·expₖ) is the largest RF exposure value (e.g., SAR value, incident PD value, or absorbed PD value) in the k^{th} RF exposure distribution (RF·expₖ) measured with radio at transmit power Txₖ, Txₖ is the transmit power applied at the antenna while collecting the k^{th} RF exposure distribution, and RF_exposure_design_target may be a target RF exposure limit. In certain cases, RF_exposure_design_target may be lower than the regulatory RF exposure limit to account for device uncertainties and/or to budget enough RF exposure margin to comply with total RF exposure in simultaneous transmission scenarios with other transmitters not included inside the RF exposure time-averaging operation. A regulatory exposure limit may include an RF exposure limit set by a regulatory body (e.g., the FCC) and/or provided by a standards body (e.g., the IEEE or the International Commission on Non-Ionizing Radiation Protection (ICNIRP)). Thus, the time-averaged RF exposure exhibited by a wireless device may be kept in compliance with the respective regulatory RF exposure limit by maintaining the time-averaged transmit power for the kl RF exposure distribution to less than or equal to Pₗᵢₘᵢₜₖ. Pₗᵢₘᵢₜₖ may vary with technology, operating frequency band, transmitting antenna, and/or device position relative to the human body (which may be referred to as “device state index”).

### Example RF Exposure Compliance Based on Spatial Information

In certain cases, although antennas may be positioned in different locations across a wireless device, a time-averaging algorithm for RF exposure compliance may assume the peak locations of RF exposure (also referred to as RF exposure hotspots) from all transmit antennas are collocated on the wireless device. Under such an assumption, the total transmit power of all transmit antennas may be limited regardless of the actual exposure scenario (e.g., head exposure, body exposure, or extremity exposure) of separate antennas. For example, suppose the user's hand covers one location on the wireless device, while RF exposure hotspots from specific antennas are not covered by the user's hand. That is, antennas may contribute to the RF exposure differently depending on the location of the exposure. Enforcing the collocated model may lead to limiting the transmit power of specific antennas whose RF exposures hotspots are not actually covered by the user's hand. That is, the assumption that all RF exposure hotspots from transmit antennas are collocated for RF exposure compliance may result in a needlessly low transmit power, which may affect uplink performance such as uplink data rates, uplink carrier aggregation, and/or an uplink connection at the edge of a cell.

Similarly, in cases where antennas are grouped into one or more antenna groups, a time-averaging algorithm for RF exposure compliance may assume all RF exposure hotspots from transmit antennas within a given antenna group are collocated. Under such an assumption, the total transmit power of all transmit antennas within the antenna group may be limited regardless of the actual exposure scenario of separate antennas within the antenna group. For example, the peak locations of RF exposure may not be at the same location for all antennas of an antenna group. Accordingly, enforcing the collocated model for an antenna group may also lead to limiting the transmit power of specific antennas within the antenna group. That is, the assumption that all RF exposure hotspots from transmit antennas within the antenna group are collocated for RF exposure compliance may result in a needlessly low transmit power, which may affect uplink performance such as uplink data rates, uplink carrier aggregation, and/or an uplink connection at the edge of a cell.

Aspects of the present disclosure provide various techniques for determining RF exposure contribution information associated with antennas of a wireless device. The RF exposure contribution information may include, for each antenna, a respective indication of spatial contribution of RF exposure from the antenna on each other antenna of the wireless device. In certain aspects, the indications of spatial RF exposure contributions for each antenna may be represented with an RF exposure contribution matrix, which includes a respective contribution factor (or contribution ratio) corresponding to a level of interaction of RF exposure from the antenna on another antenna. Assuming a wireless device has n antennas, the contribution matrix for each antenna may be a n-by-n square matrix. Each contribution matrix may be based on spatial information obtained from RF exposure distributions associated with the antennas and/or information indicating spatial separation distances between the antennas.

In certain aspects, determining the contribution matrix for each antenna may involve determining a composite RF exposure distribution based on multiple RF exposure distributions for the antenna for one or more transmit scenarios supported by the wireless device. In certain cases, determining the composite RF exposure distribution for each antenna may involve combining the RF exposure distributions for all supported transmit scenarios of the antenna. In certain other cases, determining the composite RF exposure distribution for each antenna may involve, for each frequency band of each transmit scenario supported by the wireless device, combining the RF exposure distributions for a subset of frequencies (e.g., lowest frequency, middle frequency, and highest frequency) of the frequency band. In certain other cases, determining the composite RF exposure distribution for each antenna may involve, combining the RF exposure distributions from all frequency bands supported by that antenna in the wireless device.

In certain aspects, determining the contribution matrix may further include, for each antenna “i”-to-antenna “j” combination, (a) iteratively sweeping through contour levels from the composite RF exposure distribution of the first antenna (e.g., antenna “i”) to determine the worst contribution (e.g., highest contribution) from the composite RF exposure distribution of the second antenna (e.g., antenna “j”) to each of the contour levels from the composite RF exposure distribution of the first antenna, and (b) determining a contribution factor (or contribution ratio) corresponding to a level of interaction of RF exposure from the second antenna to the first antenna based on the highest out of all the worst contributions. In general, techniques herein allow for selecting the granularity of the composite RF exposure distributions. For example, the composite RF exposure distributions can be determined per technology/frequency band/antenna/DSI of a transmit scenario by grouping all frequencies/channels of a given frequency band, grouping different technologies/frequency bands of a transmit scenario for a given antenna, determining separate contributions for different surfaces, and/or some other transmit scenario combination.

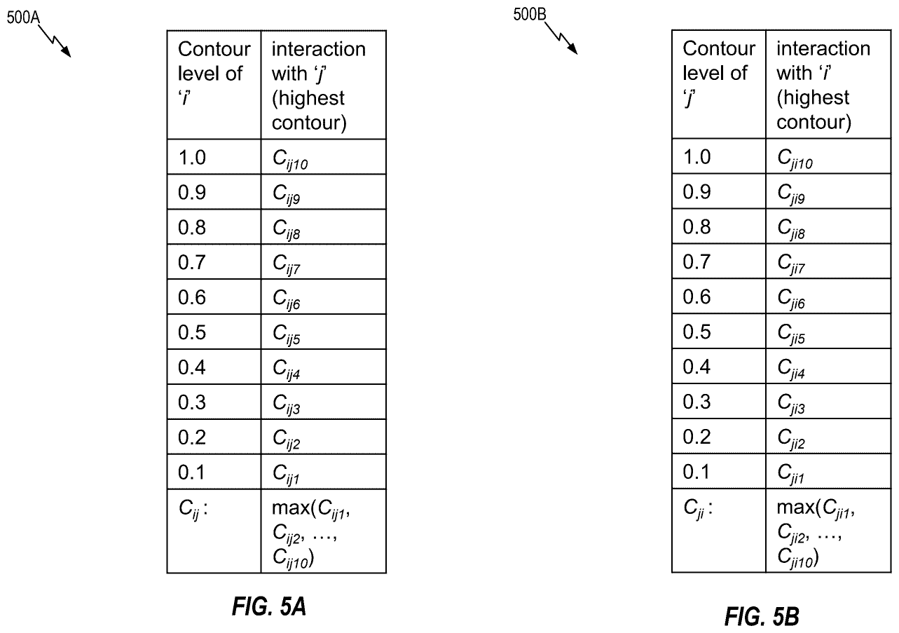

By way of example, FIG. 5A illustrates a table 500A depicting, for each contour level of the composite RF exposure distribution of antenna “i,” the highest contour level of the composite RF exposure distribution of antenna “j” that interacts with the contour level of the composite RF exposure distribution of antenna “i.” Note, when sweeping through the contour levels (e.g., 1.0, 0.9, 0.8, . . . , 0.1) from the composite RF exposure distribution of the first antenna (e.g., antenna “i”), each of the worst contributions from the second antenna (e.g., antenna “j”) should be less than or equal to the amplitude of the contour of the first antenna (e.g., antenna “i”) under investigation. For example, for table 500A, Cᵢⱼ₁₀ should be less than or equal to the contour level of “1.0,” Cᵢⱼ₉ should be less than or equal to the contour level of “0.9,” Cᵢⱼ₈ should be less than or equal to the contour level of “0.8,” and so on. Note while table 500A shows 10 contour levels being evaluated for the composite RF exposure distribution of antenna “i,” it should be noted that techniques described herein can evaluate any number of contour levels for a given composite RF exposure distribution for an antenna.

As further shown in FIG. 5A, the contribution factor Cᵢⱼ is equal to a maximum of the highest contour levels of the composite RF exposure distribution of antenna “j” that interacts with the composite RF exposure distribution of antenna “i” (e.g., Cᵢⱼ=max (Cᵢⱼ₁, Cᵢⱼ₂, . . . , Cᵢⱼ₁₀).

Similarly, determining the contribution matrix may further include, for each antenna “j”-to-antenna “i” combination, (a) iteratively sweeping through contour levels from the composite RF exposure distribution of the second antenna (e.g., antenna “j”) to determine the worst contribution (e.g., highest contribution) from the composite RF exposure distribution of the first antenna (e.g., antenna “i”) to each of the contour levels from the composite RF exposure distribution of the second antenna, and (b) determining a contribution factor (or contribution ratio) corresponding to a level of interaction of RF exposure from the first antenna to the second antenna based on the highest out of all the worst contributions. Note, when sweeping through the contour levels from the composite RF exposure distribution of the second antenna, each of the worst contributions from the first antenna (e.g., antenna “i”) should be less than or equal to the amplitude of the contour of the second antenna (e.g., antenna “j”) under investigation.

By way of example, FIG. 5B illustrates a table 500B depicting, for each contour level of the composite RF exposure distribution of antenna “j,” the highest contour level of the composite RF exposure distribution of antenna “i” that interacts with the contour level of the composite RF exposure distribution of antenna “j.” Note, when sweeping through the contour levels (e.g., 1.0, 0.9, 0.8, . . . , 0.1) from the composite RF exposure distribution of the second antenna, each of the worst contributions from the first antenna (e.g., antenna “i”) should be less than or equal to the amplitude of the contour of the second antenna (e.g., antenna “j”) under investigation. For example, for table 500B, Ciao should be less than or equal to the contour level of “1.0,” Cⱼᵢ₉ should be less than or equal to the contour level of “0.9,” Cⱼᵢ₈ should be less than or equal to the contour level of “0.8,” and so on. Note while table 500B shows 10 contour levels being evaluated for the composite RF exposure distribution of antenna “j,” it should be noted that techniques described herein can evaluate any number of contour levels for a given composite RF exposure distribution for an antenna.

As further shown in FIG. 5B, the contribution factor Cⱼᵢ is equal to a maximum of the highest contour levels of the composite RF exposure distribution of antenna “i” that interacts with the composite RF exposure distribution of antenna “j” (e.g., Cⱼᵢ=max (Cⱼᵢ₁, Cⱼᵢ₂, . . . , Cⱼᵢ₁₀).

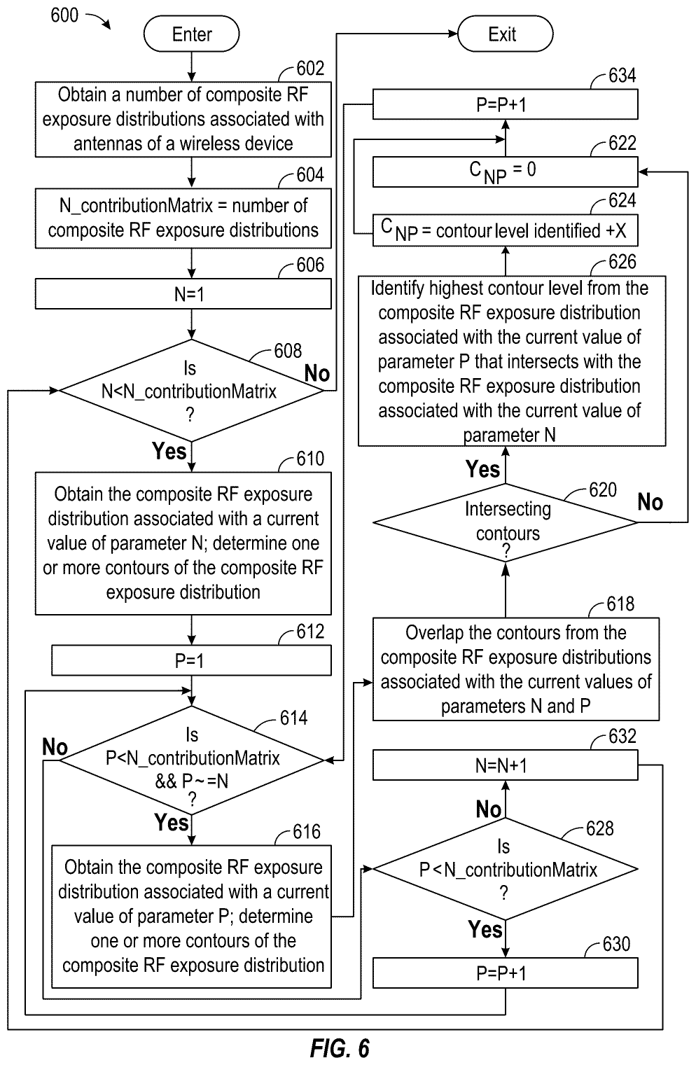

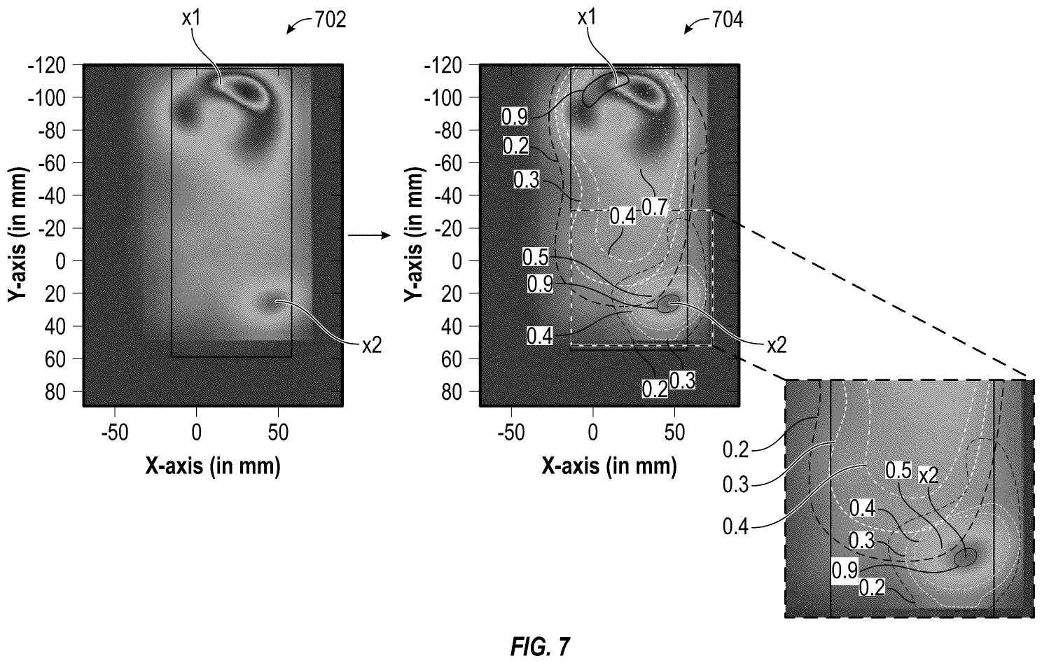

FIG. 6 is a flow diagram illustrating example operations 600 for generating an RF exposure contribution information for an antenna, in accordance with certain aspects of the present disclosure. The operations 600 may be performed using an RF exposure measurement system (e.g., RF exposure measurement system 400), a processing system (e.g., the processing system 402), or any other computational device. As described herein with respect to the operations 600, FIG. 7 is a diagram illustrating the progression of generating the RF exposure contribution information, according to certain aspects of the present disclosure.

The operations 600 may optionally begin at block 602, where the processing system obtains a number of composite RF exposure (e.g., SAR and/or PD) distributions associated with antennas (e.g., antennas 218) of a wireless device (e.g., wireless device 102). For example, the processing system may obtain a respective composite RF exposure distribution for each antenna of the wireless device. As noted, in certain aspects, the composite RF exposure distribution for each antenna may involve combining the RF exposure distributions for all supported transmit scenarios of the antenna. In certain other aspects, the composite RF exposure distribution for each antenna may involve, for each frequency band of each transmit scenario supported by the wireless device, combining the RF exposure distributions for a subset of frequencies (e.g., lowest frequency, middle frequency, and highest frequency) of the frequency band.

In some cases, the composite RF exposure distributions may be generated via simulations, such as a simulation of the various transmit scenarios using a model of the human body being exposed to electromagnetic radiation from a wireless device. As used herein, a transmit scenario may refer to various combinations of radios (e.g., radio(s) 250 of FIG. 2), communication technologies (e.g., RAT(s)), antennas (e.g., antenna(s) 218 of FIG. 2), antenna groupings (or antenna groups), antenna configurations, SISO or MIMO transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions).

The composite RF exposure distributions (also referred to as composite RF exposure maps) may be representative of the RF exposure in terms of SAR and/or PD. Additionally, the composite RF exposure distributions may be normalized with respect to the respective RF exposure limit (e.g., SAR limit and/or PD limit). Each composite RF exposure distribution for an antenna may cover the RF exposure exhibited by the antenna for each transmit scenario (or subset thereof) supported by a wireless device. For example, the composite RF exposure distribution may include one or more regions where each region is representative of an actual point or area of the wireless device or may not be representative of an actual point or area of the wireless device. In some cases, for example, a region of the composite RF exposure distribution may be representative of one or more points on the wireless device. For instance, a region may be representative of a single point on the wireless device or a set of points on the wireless device. In cases where the region is representative of a set of points on the wireless device, the set of points may be a set of contiguous points or a set of non-contiguous (or scattered) points. In some cases, a region of the composite RF exposure distribution may be representative of a collection of a set of points on the wireless device, where each respective set of points corresponds to a different area (within the region) of the wireless device. Each respective set of points within the collection may include contiguous points or non-contiguous points.

At block 604, the processing system initializes a parameter “N_contributionMatrix” representative of the number of contribution matrices. At block 604, for example, the processing system may set N_contributionMatrix equal to the number of composite RF exposure distributions obtained in block 602.

At block 606, the processing system initializes a parameter “N” to “1.” At block 608, the processing system determines whether the value of parameter “N” is less than the value of parameter “N_contributionMatrix.” If so, then the operations 600 proceed to block 610. If not, then the operations 600 may exit.

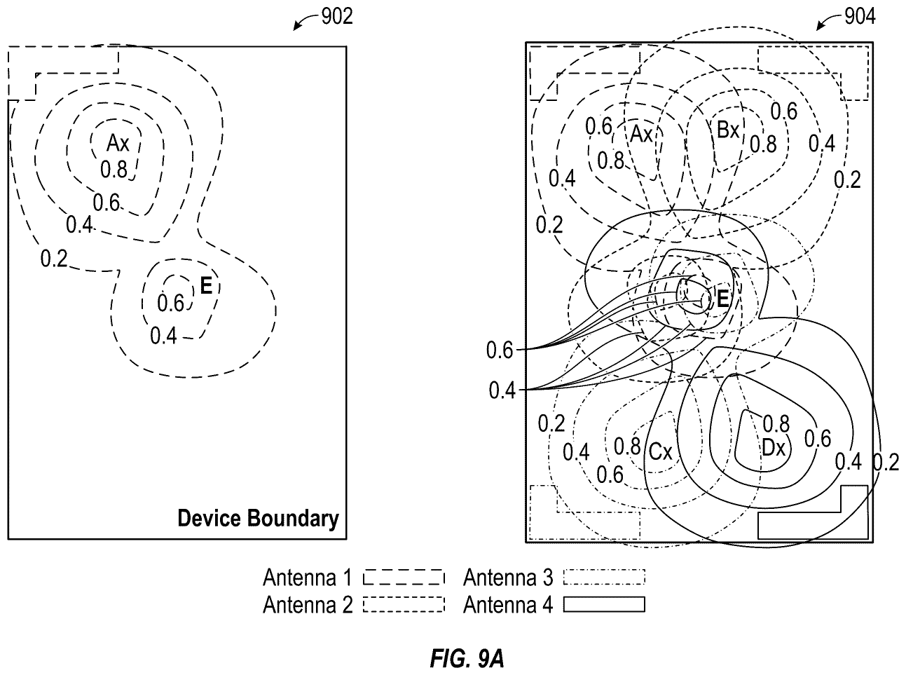

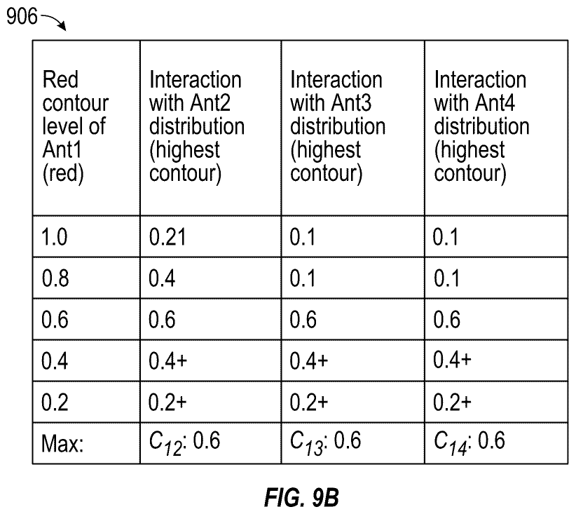

At block 610, the processing system may obtain the composite RF exposure distribution associated with a current value of parameter “N” and determine one or more contours of the composite RF exposure distribution. In certain aspects, the processing system may plot contours in X steps starting from 1, where X may be a preset or configurable step size. Each contour level may be any non-zero value less than or equal to 100%. Each contour represents the region boundary inside which all the points have a value higher (greater) than or equal to the contour threshold (e.g., normalized RF exposure value). For example, a contour level of “1.0” may represent the region boundary inside which all the points have a value higher than or equal to normalized RF exposure value=1, a contour level of “0.9” may represent the region boundary inside which all the points have a value higher than or equal to normalized RF exposure value=0.9, and so on. Additionally, note that a contour may be a point, or a set of scattered points, or a set of contiguous points forming an area, or multiple disjointed areas (e.g., contour=0.4 in composite RF exposure distribution 902 of FIG. 9A is in two disjointed areas, one area enclosing location A and another area enclosing location E).

At block 612, the processing system initializes a parameter “P” to “1.” At block 614, the processing system determines whether (i) the value of parameter “P” is less than the value of parameter “N_contributionMatrix” and (ii) the value of parameter “P” is not equal to the value of parameter “N.” If so, then the operations 600 proceed to block 616. If not, then the operations 600 proceed to block 628.

At block 616, the processing system obtains the composite RF exposure distribution associated with a current value of parameter “P” and determines one or more contours of the composite RF exposure distribution. In certain aspects, the processing system may plot contours in X steps starting from 1, where X is a configurable step size. The operations associated with block 616 may be similar to the operations associated with block 610.

At block 618, the processing system overlaps the contours from the composite RF exposure distribution associated with the current value of parameter “N’ and the composite RF exposure distribution associated with the current value of parameter “P.” By way of example, FIG. 7 illustrates a composite RF exposure map 702 in which the composite RF exposure distributions of two antennas (e.g., antenna “i” and antenna “j”) are overlapped. In the composite RF exposure map 702, “x1” represents the RF exposure hotspot or maximum RF exposure point for antenna “i” and “x2” represents the RF exposure hotspot or maximum RF exposure point for antenna “j.” As shown, the maximum RF exposure points for antenna “i” and antenna “j” are spatially apart. Additionally, FIG. 7 also illustrates a composite RF exposure map 704 which includes an overlapping of the contours for the composite RF exposure distribution of antenna “i” with the contours for the composite RF exposure distribution of antenna “j.” Here, the solid contour lines represent the various levels of normalized RF exposure (e.g., SAR and/or PD) for antenna “i,” and the dashed/dotted lines represent the various levels of normalized RF exposure for antenna “j.”

Referring back to FIG. 6, at block 620, the processing system determines whether any contours from the composite RF exposure distribution associated with the current value of parameter “P,” intersect with the contours from the composite RF exposure distribution associated with the current value of parameter “N.” If so, then the operations 600 proceed to block 626. If not, then the operations 600 proceed to block 622.

At block 622, the processing system sets a contribution factor representative of a level of interaction of the contours from the composite RF exposure distribution associated with the current value of parameter “P” with the contours from the composite RF exposure distribution associated with the current value of parameter “N” to zero (e.g., C_{NP}=0). In certain aspects, a contribution factor equal to zero may indicate that the RF exposure associated with antenna “P” does not interact with the RF exposure associated with antenna “N.”

At block 626, the processing system identifies the highest contour level from the composite RF exposure distribution associated with the current value of parameter “P” that intersects with the composite RF exposure distribution associated with the current value of parameter “N.” Note, at block 626, the highest contour level from the composite RF exposure distribution associated with the current value of parameter “P” that intersects with the composite RF exposure distribution associated with the current value of parameter “N” should be less than or equal to the amplitude of the contour of the composite RF exposure distribution associated with the current value of parameter “N” under investigation. By way of example, with the composite RF exposure map 704 illustrated in FIG. 7, the highest interaction of antenna i's 0.3 contour (e.g., normalized RF exposure >0.3) that overlaps with antenna j's composite RF exposure distribution (and is less than or equal to the amplitude of antenna i's 0.3 contour) is antenna j's 0.2 contour (e.g., normalized RF exposure >0.2), whereas the highest interaction of antenna j's 0.4 contour (e.g., normalized RF exposure >0.4) that overlaps with antenna i's composite RF exposure distribution (and is less than or equal to the amplitude of antenna j's 0.4 contour) is antenna i's 0.3 contour. These highest contour values may be used to populate a contribution matrix for each of antenna “i” and antenna “j.”

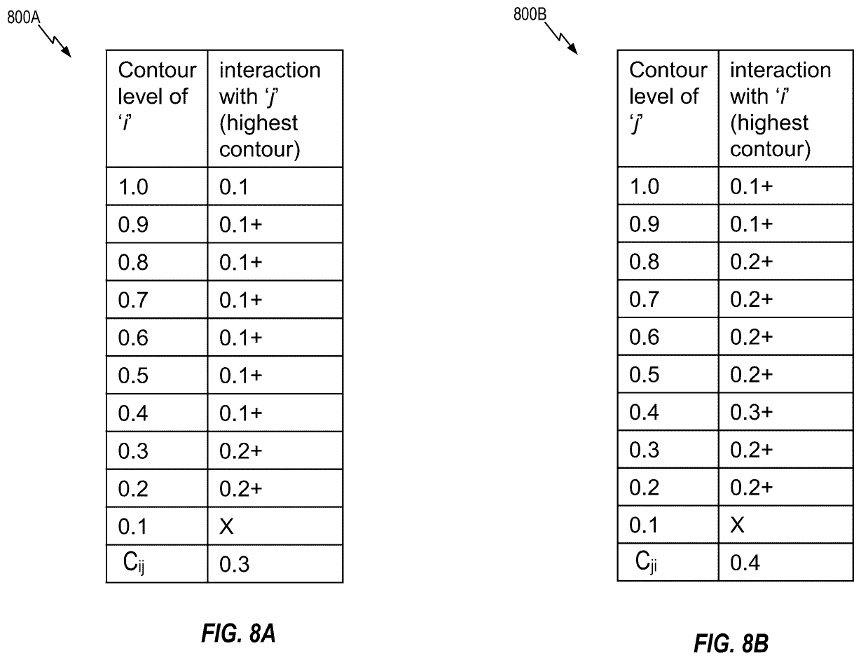

By way of example, FIG. 8A illustrates a table 800A depicting, for each contour level of antenna i's composite RF exposure distribution in the composite RF exposure map 704, the highest contour level of antenna j's composite RF exposure distribution in the composite RF exposure map 704 that interacts with the contour level of antenna i's composite RF exposure distribution in the composite RF exposure map 704. In table 800A, the “+” operator indicates that the interaction with antenna ‘j” is with a contour level higher than antenna i's contour. Thus, the highest contour level for such an entry is limited to antenna i's contour level. Additionally, in table 800A, the value “X” (e.g., X for antenna i's contour level=0.1) may indicate that none of antenna j's contour levels interact with antenna i's contour level (e.g., antenna i's contour level=0.1).

Similarly, FIG. 8B illustrates a table 800B depicting, for each contour level of antenna i's composite RF exposure distribution in the composite RF exposure map 704, the highest contour level of antenna i's composite RF exposure distribution in the composite RF exposure map 704 that interacts with the contour level of antenna j's composite RF exposure distribution in the composite RF exposure map 704. In table 800B, the “+” operator indicates that the interaction with antenna “i” is with a contour level higher than antenna j's contour. Thus, the highest contour level for such an entry is limited to antenna j's contour level. Additionally, in table 800B, the value “X” (e.g., X for antenna j's contour level=0.1) may indicate that none of antenna i's contour levels interact with antenna j's contour level (e.g., antenna j's contour level=0.1).

At block 624, the processing system sets a contribution factor representative of a level of interaction of the contours from the composite RF exposure distribution associated with the current value of parameter “P” with the contours from the composite RF exposure distribution associated with the current value of parameter “N” to the contour level identified in block 626 plus a predefined value equal to X (e.g. C_{NP}=contour level identified+X).

At block 634, the processing system increments the value of the parameter “P” by 1 (e.g., P=P+1). At block 628, the processing system determines whether the value of parameter “P” is less than the value of parameter “N_contributionMatrix.” If so, then the operations 600 proceed to block 630. If not, then the operations 600 proceed to block 632. At block 630, the processing system increments the value of the parameter “P” by 1 (e.g., P=P+1), and the operations 600 proceed to block 614. At block 632, the processing system increments the value of the parameter “N” by 1 (e.g., N=N+1), and the operations 600 proceed to block 608.

Note, the techniques described herein for sweeping through the contour levels of each antenna (e.g., an iterative contour approach) to determine the worst (e.g., highest) contribution of RF exposure from another antenna on the antenna may be distinct from determining a contribution matrix for the antenna using the contribution of RF exposure from another antenna's RF exposure hotspot(s). That is, in certain cases, RF exposure compliance may not be guaranteed by solely determining a contribution factor representative of interaction of the highest contour of antenna j's composite RF exposure distribution on the RF exposure hotspot(s) of antenna i's composite RF exposure distribution (e.g., contour level=1.0).

By way of example, consider FIG. 9A which depicts a composite RF exposure distribution 902 for a first antenna (e.g., antenna 1) and a composite RF exposure distribution 904 including overlapped composite RF exposure distributions for the first antenna, a second antenna (e.g., antenna 2), a third antenna (e.g., antenna 3), and a fourth antenna (e.g., antenna 4). Here, the RF exposure hotspot for antenna 1 is at location “A,” the RF exposure hotspot for antenna 2 is at location “B,” the RF exposure hotspot for antenna 3 is at location “C,” and the RF exposure hotspot for antenna 4 is at location “D.” Each of antennas 1 to 4 may have a secondary RF exposure hotspot at location “E.”

In certain scenarios, computing a contribution matrix for antenna 1 solely based on the highest level of interaction from each of the composite RF exposure distributions from antenna 2, antenna 3, and antenna 4 on the RF exposure hotspot for antenna 1 may result in a lower amount of contribution than if the contribution matrix were computed using an interactive contour approach described herein. As shown in table 906 of FIG. 9B, for example, the highest interaction of antenna 2's composite RF exposure distribution on antenna 1's RF exposure hotspot (e.g., antenna 1's 1.0 contour) is 0.21, whereas the highest interaction of antenna 2's composite RF exposure distribution on antenna 1's composite RF exposure distribution is 0.6. Similarly, the highest interaction of antenna 3's composite RF exposure distribution on antenna 1's RF exposure hotspot (e.g., antenna 1's 1.0 contour) is 0.1, whereas the highest interaction of antenna 3's composite RF exposure distribution on antenna 1's composite RF exposure distribution is 0.6. Lastly, the highest interaction of antenna 4's composite RF exposure distribution on antenna 1's RF exposure hotspot (e.g., antenna 1's 1.0 contour) is 0.1, whereas the highest interaction of antenna 4's composite RF exposure distribution on antenna 1's composite RF exposure distribution is 0.6.

In another illustrative example, consider a scenario in which a wireless device including 4 antennas (e.g., antenna 1, antenna 2, antenna 3, and antenna 4) has a 4×4 matrix of contributions from antenna “i's” location to antenna ‘j's” location. In this scenario, antenna 1's RF exposure hotspot is at location “A,” antenna 2's RF exposure hotspot is at location “B,” antenna 3's RF exposure hotspot is at location “C,” and antenna 4's RF exposure hotspot is at location “D.” Location E may be a secondary RF exposure hotspot for each of antennas 1 to 4.

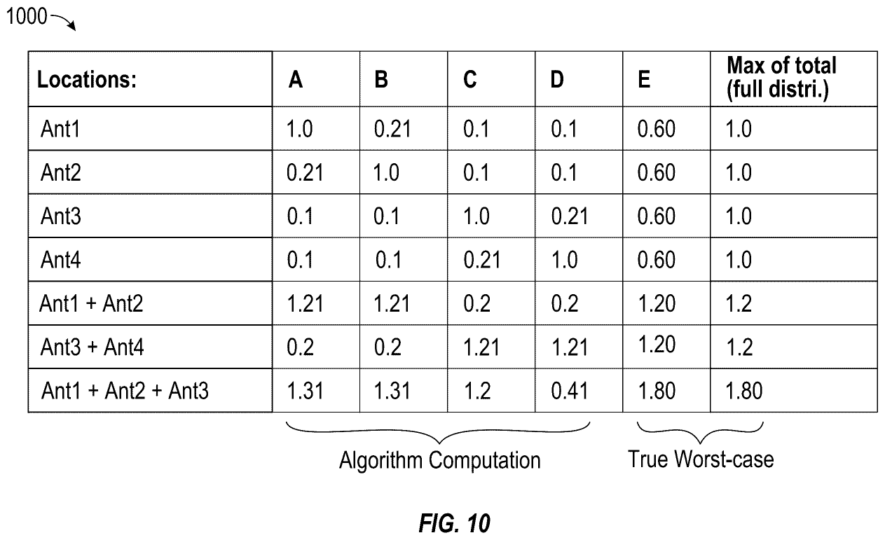

In the aforementioned scenario, table 1000 illustrated in FIG. 10 includes the RF exposure contributions for each of antennas 1 to 4, based solely on the peak locations of RF exposure for the antenna. However, in certain cases, RF exposure compliance may not be met when the RF exposure contributions are stored based solely on contributions at the peak locations of RF exposure.

In an illustrative example, RF exposure compliance may not be met when transitioning from a 2 transmit antenna scenario (e.g., antenna 1+antenna 2) to another 2 transmit antenna scenario (e.g., antenna 3+antenna 4), as the previous history has exposure at 1.21 for current location of 0.2 and vice versa (the additive value is 1.41), e.g., as shown in table 1000 of FIG. 10. Additionally, as shown in table 1000, the worst (highest) case overlap (e.g., 1.2+1.2=2.4) may be at location E, which may not be considered by an algorithm computation using solely contributions at the peak locations of RF exposure.

In another illustrative example, as shown in table 1000, RF exposure compliance may not be met during a transmit scenario involving more than two antennas (e.g., antenna 1+antenna 2+antenna 3 showing a maximum value of 1.31) as the worst location (e.g., location E with amplitude of 1.8) is not evaluated by an algorithm computation using solely contributions at the peak locations of RF exposure. Hence, this approach (table 1000) cannot guarantee compliance as the worst-case exposure is underestimated (1.31 for antenna 1+antenna 2+antenna 3 active transmission scenario versus actual value of 1.8 at location E).

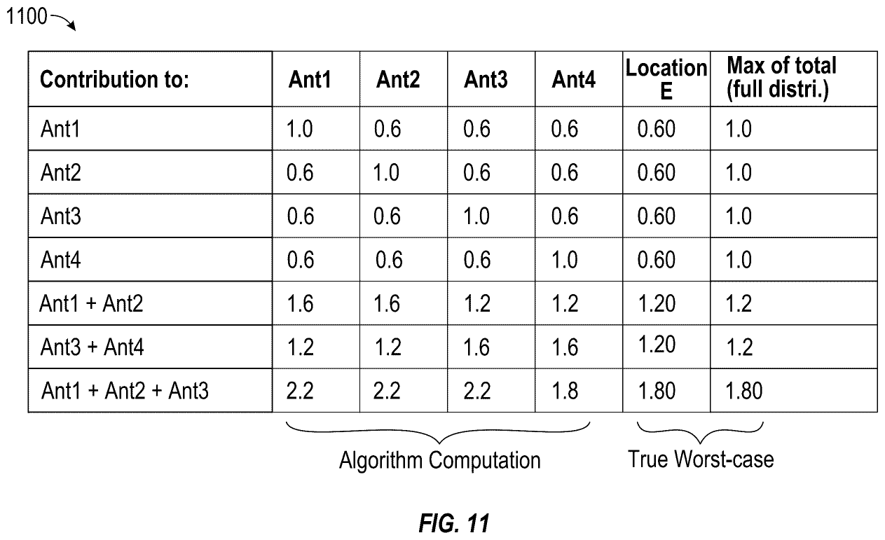

On the other hand, consider table 1100 illustrated in FIG. 11 which includes the contributions for each of antennas 1 to 4 determined using an iterative contour approach described herein. In an illustrative example, when using the table 1100 as opposed to the table 1000, RF exposure compliance may be met when transitioning from a 2 transmit antenna scenario (e.g., antenna 1+antenna 2) to another 2 transmit antenna scenario (e.g., antenna 3+antenna 4), as the previous history has exposure at 1.6 for current location of 1.2 and vice versa (additive value is 2.8). Note, this computation may be conservative (e.g., higher) compared to the worst-case overlap (e.g., 1.2+1.2=2.4) at location E using full distributions.

In another illustrative example, when using the table 1100 as opposed to the table 1000, RF exposure compliance may be met during transmit scenarios involving more than 2 antennas (e.g., antenna 1+antenna 2+antenna 3 showing a maximum value of 2.2) as the worst location (e.g., location E with amplitude of 1.80) is evaluated in an iterative contour approach. Hence, this approach (table 1100) for determining contributions can guarantee compliance as the worst-case exposure is overestimated (2.2 for antenna 1+antenna 2+antenna 3 active transmission scenario versus actual value of 1.8 at location E).

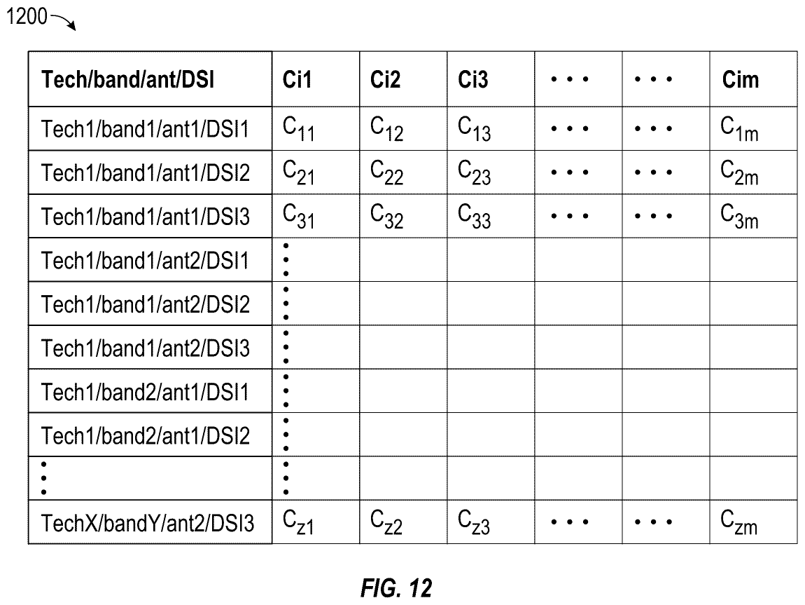

FIG. 12 illustrates an example contribution matrix 1200 for a wireless device, according to certain aspects of the present disclosure. The contribution matrix 1200 may include a set of contribution factors for each combination of technology/frequency band/antenna/DSI (or, more generally, a transmit scenario). Here, for example, the contribution matrix 1200 includes a set of “m” contribution factors for each combination of technology/frequency band/antenna/DSI. In certain aspects, “m” is representative of a number of antennas of the wireless device (e.g., m=n for n antennas of the wireless device). In certain other aspects, “m” is representative of a number of composite RF exposure distributions (or maps) for the wireless device (e.g., m=N composite RF exposure distributions (tech/band/ant/DSI)). In certain other aspects, “m” is representative of a number of regions of an RF exposure distribution(s) (e.g., composite RF exposure distribution) associated with the wireless device (e.g., m=m regions, where m regions may be less than n antennas of the wireless device, greater than n antennas of the wireless device, or equal to n antennas of the wireless device). In certain other aspects, “m” is representative of a number of surfaces of the wireless device (e.g., m=6 for 6 surfaces of the wireless device).

Note, while the contribution matrix 1200 depicted in FIG. 12 assumes a two antenna and 3 DSI system with X technologies and Y frequency bands (e.g., for a total of “z” records), note that a contribution matrix generated using the techniques described herein may include any number of antennas, DSIs, technologies, and/or frequency bands. Additionally, note that while many aspects described herein assume the contribution factors may have a value between 0 and 1, in certain aspects, the contribution factors may have a value within another predefined range.

Additionally, note that the contribution matrix 1200 is an illustrative example of a contribution matrix and that a contribution matrix may include contribution factors for different transmit scenarios. In certain aspects, for example, the contribution matrix 1200 may include both SISO and MIMO entries. For instance, for a 2×2 MIMO configuration, the contribution matrix may indicate configuration factors for all supported antenna pairs. In certain aspects, the contribution matrix 1200 may include solely SISO entries. In such aspects, the MIMO entries may be derived using a time-averaging algorithm for RF exposure compliance, based on respective SISO entries of individual antennas part of the MIMO transmission.

As noted, certain aspects described herein provide techniques for performing a time-averaged RF exposure compliance evaluation using the RF exposure contribution information (e.g., contribution matrix 1200) generated using the iterative contour approach described herein. For example, a wireless device may evaluate RF exposure compliance based on the RF exposure contribution information, e.g., as part of a time-averaged operation. The wireless device may perform an RF exposure assessment of past RF exposure over a given time window using the RF exposure contribution information described herein to determine a maximum allowable transmit power for a future time interval in the time window. The time-averaged operation may track a normalized RF exposure history over the time window for each radio, and the wireless device may sum the normalized RF exposures of all active radios in simultaneous transmission scenarios. The sum of normalized RF exposure associated with the radios may use the respective RF exposure contribution associated with each of the antenna(s) for the radios.

The apparatus and methods for performing a time-averaged RF exposure compliance evaluation using the RF exposure contribution information described herein may facilitate improved wireless communication performance in terms of improved signal quality at the receiver, higher throughput, decreased latency, and increased range, as illustrative examples. For example, the time-averaged RF exposure compliance evaluation based on the spatial information of RF exposure contributions among antennas may provide an accurate assessment of the RF exposure occurring at locations across the wireless device allowing the wireless device to determine a higher maximum allowable transmit power limit for certain transmissions.

In certain aspects, the RF exposure contribution information may include, for each antenna, a respective contribution matrix with contribution factors associated with each other antenna of a wireless device. In certain other aspects, the RF exposure contribution information may include, for each antenna within each antenna group, a respective contribution matrix with contribution factors associated with each other antenna in the antenna group.

In certain aspects, the time-averaged RF exposure compliance evaluation based on the RF exposure contribution information described herein may be represented using the following:

$${\sum }_{i = 1}^{p} [ \frac{1}{Ti} {\int }_{t - Ti}^{t - Δ t} \{ \frac{Tx . pwr . radio . i ( t )}{Plimit . i} * [ {C}_{i 1} , {C}_{i 2} , … , {C}_{i m} ] \} ] + {\sum }_{i = 1}^{p} [ \frac{Δt}{Ti} * exp . radio . i ( Δ t ) * [ {C}_{i 1} , {C}_{i 2} , … , {C}_{i m} ] ] \leq 1. \qquad ( 8 )$$

where p is the number of active radios of the wireless device (e.g., p active radios represented by i=1, 2, . . . , p), Ti is the operating time-averaging window for the i^{th} radio, Plimit.i is the transmit power limit of the i^{th} radio, Tx.pwr.radio.i(t) is the transmit power of the i^{th} radio in a prior time interval (e.g., between time instances t−Ti and t−Δt) associated with Ti, exp.radio.i(Δt) is allowed exposure margin for the i^{th} radio in a future time interval (e.g., Δt) associated with Ti, and [Cᵢ₁, Cᵢ₂, . . . , Cᵢₘ] is a set of m contribution factors. In certain aspects, the RF exposure contribution information (e.g., contribution matrix 1200) may be generated using the iterative contour approach described herein, where each contribution factor is representative of a highest level of interaction of another antenna on the antenna(s) for the i^{th} radio, resulting in m=N antennas or in certain aspects, the contribution matrix 1200 may be a square matrix. In general, each contribution factor may be representative of a highest level of interaction of another RF exposure contributor on the antenna(s) for the i^{th} radio, such that m=N antennas when the RF exposure contributors are representative of antennas of the wireless device, m=m regions when the RF exposure contributors are representative of regions of an RF exposure map, and m=number of surfaces, when the RF exposure contributors are representative of surfaces of the wireless device.

The time-averaged RF exposure compliance evaluation in Equation (8) computes exposure consumed in a past regulatory time window—Δt to evaluate the exposure margin available for a future Δt that the radio is allowed to transmit (e.g., Tx.pwr.radio.i(Δt)) while remaining compliant with the regulatory exposure limit. For example, the transmit power of the i^{th} radio in the future Δt may be represented with the following:

$$Tx . pwr . radio . i ( Δ t ) = exp . radio . i ( Δ t ) * Plimit . i \qquad ( 9 )$$

In certain aspects, performing the time-averaged RF exposure compliance evaluation based on RF exposure contribution information may provide a higher transmit power for the i^{th} radio, resulting in higher performance for the i^{th} radio compared to the performance for the i^{th} radio without the RF exposure contribution information. For example, as indicated in Equation (8), the consumed exposure (e.g., Tx.pwr.radio.i(t)/Plimit.i) for the i^{th} radio is multiplied by the corresponding contribution ratio (Cij) and stored. Since contribution ratios are typically ≤1, it follows that the time-averaged consumed exposure may be lower (compared to the time-averaged consumed exposure without contribution factors), resulting in more available margin (while time-averaged exposure remains under regulatory limit) and providing a higher transmit power for the i^{th} radio (compared to the time-averaged RF exposure compliance evaluation without contribution factors).

In certain aspects, performing a time-averaged RF exposure compliance evaluation for RF exposure compliance based on RF exposure contribution information may involve performing an individual time-averaged RF exposure compliance evaluation for each contribution factor within a contribution matrix. For example, assuming the RF exposure contribution information includes a set of m contribution factors within the respective contribution matrix for an antenna of the i^{th} radio, each time-averaged RF exposure compliance evaluation may be represented with the following:

$${\sum }_{i = 1}^{p} [ \frac{1}{Ti} {\int }_{t - Ti}^{t - Δ t} \{ \frac{Tx . pwr . radio . i ( t )}{Plimit . i} * [ {C}_{ij} ] \} ] + {\sum }_{i = 1}^{p} [ \frac{Δ t}{Ti} * exp . radio . ij ( Δ t ) ] \leq 1. \qquad ( 10 )$$

where Cᵢⱼ is the j^{th} contribution factor (e.g., j∈{1, 2, . . . , m}) associated with the antenna for the i^{th} radio.

In certain aspects, the i^{th} radio's allowable power to transmit in the future time interval (e.g., Tx.pwr.radio.i(Δt)) may be based on the multiple (e.g., m) time-averaged operations. For example, a respective provisional transmit power limit may be determined using each time-averaged RF exposure compliance evaluation, and the minimum of the provisional transmit power limits may be selected as the i^{th} radio's allowable power to transmit in the future time interval (e.g., Tx.pwr.radio.i(Δt)). By way of example, the allowed exposure margin for the future time interval that complies with all (e.g., m) time-averaged RF exposure compliance evaluations may be represented with the following:

$$exp . radio . i ( Δ t ) = ( \frac{exp . radio . ij ( Δ t )}{{C}_{ij}} , j = 1 , 2 , … , m ) \qquad ( 11 )$$

In certain aspects, each of the provisional transmit power limits may be power boosted based on a boost factor determined based on the respective contribution factor. For example, the respective allowed transmit power limit computed from each of the multiple time-averaged RF exposure compliance evaluations may be boosted by the inverse of the contribution factor Cᵢⱼ. Here, the allowed exposure margin in the future transmission may be split among the active radios' exposure budgets (e.g.,

$$allowed . exp . budget . radio . a = \frac{Tx . pwr . radio . a ( Δ t )}{Plimit . a} ) .$$

Additionally, since the allowed exposure budget for the future transmission is multiplied by the contribution factor Cᵢⱼ when counting the allowed exposure budget as “consumed exposure” during the time-averaged RF exposure compliance evaluation, the allowed exposure budgets can be boosted using a boost factor Bᵢⱼ as shown below:

Contribution Factor 1: C₁₁*B₁₁*allowed.exp.budget.radio.1+C₂₁*B₂*allowed.exp.budget.radio.2+ . . . +Cₙ₁*Bₙ₁*allowed.exp.budget.radio.n=allowed.exp.budget.radio.1+allowed.exp.budget.radio.2+ . . . +allowed.exp.budget.radio.n

Contribution Factor 2: C₁₂*B₁₂*allowed.exp.budget.radio.1+C₂₂*B₂₂*allowed.exp.budget.radio.2+ . . . +Cₙ₂*Bₙ₂*allowed.exp.budget.radio.n=allowed.exp.budget.radio.1+allowed.exp.budget.radio.2+ . . . +allowed.exp.budget.radio.n

:

Contribution Factor m: C₁ₘ*B₁ₘ*allowed.exp.budget.radio.1+C₂ₘ*B₂ₘ*allowed.exp.budget.radio.2+ . . . +Cₙₘ*Bₙₘ*allowed.exp.budget.radio.n=allowed.exp.budget.radio.1+allowed.exp.budget.radio.2+ . . . +allowed.exp.budget.radio.n

In certain aspects, each boost function may be represented with the following:

$${B}_{ij} = 1 / {C}_{ij} \qquad ( 12 )$$

Additionally, the boosted allowed transmit power limit for a future transmission for the i^{th} radio may be represented with the following:

$$Boosted ‘ allowed Tx power limit ’ for future transmission for radio ‘ i ’ = {min}_{j = 1 to m} \{ \frac{allowed \cdot exp \cdot budget \cdot radio \cdot i}{{C}_{ij}} \} * Plimit \cdot radio \cdot i \qquad ( 13 )$$

In certain aspects, performing multiple (e.g., m) time-averaged RF exposure compliance evaluations may provide improved performance at the cost of memory/computations. For example, as noted, when performing multiple time-averaged RF exposure compliance evaluations, the consumed exposure report for each active radio for the past time window may be stored by multiplying the consumed exposure with the corresponding Cᵢⱼ, where “i” is the transmit scenario (e.g., technology/frequency band/antenna/DSI) index of the active radio and “j” represents contribution factors 1, 2, . . . , m. Here, because 0≤Cᵢⱼ≤1, the past stored exposure history may be lower, resulting in more margin available for the future transmission (e.g., allowed transmit power limit). Additionally, when performing multiple (e.g., m) time-averaged RF exposure compliance evaluations, RF exposure compliance may be met by sending the minimum allowed transit power limit for each active radio out of the multiple time-averaged RF exposure compliance evaluations to transceiver circuitry (e.g., the transceiver depicted in FIG. 2) as the power limit for transmission.

Instead of performing a respective time-averaged RF exposure compliance evaluation for each of the m contribution factors, certain aspects described herein may allow for performing a subset of time-averaged RF exposure compliance evaluations (e.g., fewer than m time-averaged RF exposure compliance evaluations) for RF exposure compliance based on RF exposure contribution information. For example, in certain cases, one or more of the contribution factors for active antenna(s) may be zero or below a threshold for a given transmit scenario index. In such cases, the time-averaged RF exposure compliance evaluation may not be run for those indices (e.g., skipped) to save computations/memory. Additionally, refraining from performing the time-averaged RF exposure compliance evaluations for these indices may not present an RF exposure compliance concern since the RF exposure contribution from these transmit scenario indices may be low. That is, if the q^{th} contribution factor is a low value (or zero) (e.g., C_{iq}=0 or low for all active “i” technology/frequency band/antenna/DSI for a given q) for active antennas and the past exposure history is low on the q^{th} time-averaged RF exposure compliance evaluation, then that time-averaged RF exposure compliance evaluation may not be run (e.g., skipped) to save computation/memory.

Note that, in certain scenarios, there may be multiple contribution factors that are low (e.g., ‘q’ indices can be more than one). Consequently, the time-averaged RF exposure compliance evaluations for all such contribution factors can be avoided to save computations/memory. In one illustrative example, assume RF exposure is evaluated on 6 surfaces of the wireless device (e.g., m=6). In this example, if a first antenna group (e.g., AG0) is at the bottom of the wireless device and if the top surface exposure is not evaluated or is zero, then the time-averaged RF exposure compliance evaluation for the first antenna group can be run on 5 surfaces (e.g., bottom, left, right, front, and back) instead of 6 surfaces. Similarly, if a second antenna group (e.g., AG1) is at the top of the wireless device, then the bottom surface can be avoided as exposure may be low for the top surface, and the time-averaged RF exposure compliance evaluation for the second antenna group may be run on 5 surfaces (e.g., top, left, right, front, and back).

In another illustrative example, if antennas in the first antenna group are located solely on the left side of the wireless device (e.g., right surface is >25 mm from all AG0 antennas meeting a regulatory exclusion criteria, such that an original equipment manufacturer (OEM) does not have to test RF exposure on the right surface for AG0 antennas), then 4 time-averaged RF exposure compliance evaluations (bottom, left, front, and back) may be performed when evaluating the first antenna group. In another illustrative example, if all antennas in the first antenna group all have j^{th} contribution factor of 1.0 (i.e., Cij=1.0, for all i=1, 2, . . . p supported radios/antennas), then the j^{th} contribution may result in the worst-case exposure, so only one time-averaged RF exposure compliance evaluation (i.e., corresponding to the j^{th} evaluation) is sufficient in such a case instead of running m time-averaged RF exposure compliance evaluations.

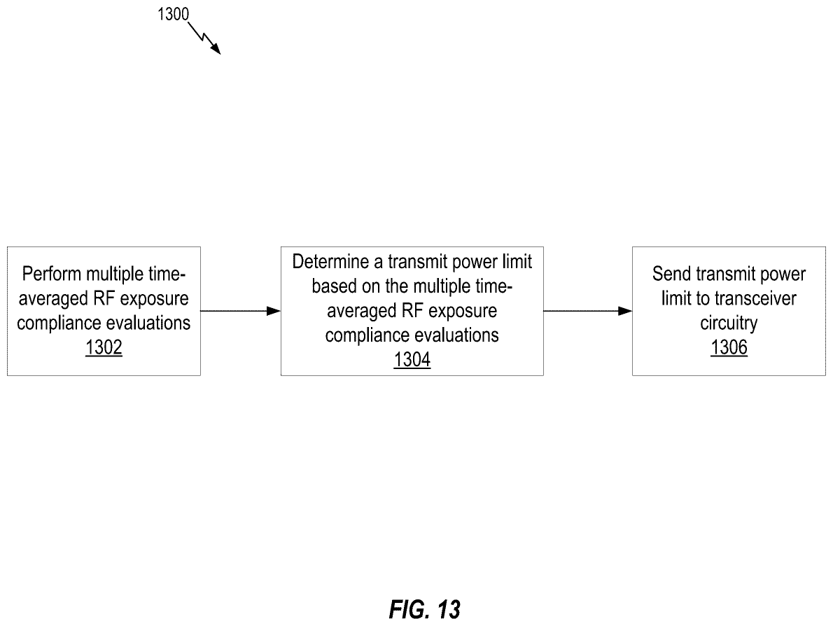

FIG. 13 illustrates an example workflow 1300 for a time-averaged RF exposure compliance evaluation based on RF exposure contribution information, according to certain aspects of the present disclosure.

As shown, the workflow 1300 may involve, at block 1302, performing multiple time-averaged RF exposure compliance evaluations. For example, at block 1302, a respective time-averaged RF exposure compliance evaluation may be performed for each contribution factor Cᵢⱼ (or contribution ratio) (e.g., m time-averaged RF exposure compliance evaluations). In certain cases, each time-averaged RF exposure compliance evaluation may include: (i) determining a consumed exposure budget for a prior time interval of a time-averaging window based on the contribution factor Cᵢⱼ (e.g., consumed exposure budget=Cᵢⱼ*RF Tx power report/Pₗᵢₘᵢₜ); (ii) performing a time-averaging operation to determine an allowed exposure margin (or budget) for a future time interval of the time-averaging window; and (iii) determining an allowed transmit power limit based in part on the allowed exposure margin, where the allowed transmit power limit is boosted by the inverse of the contribution factor Cᵢⱼ (e.g., allowed transmit power limit=allowed exposure budget*Pₗᵢₘᵢₜ/Cᵢⱼ), resulting in a higher transmit power for the radio to transmit to obtain higher performance.

The workflow 1300 may also involve, at block 1304, determining a transmit power limit based on the multiple time-averaged RF exposure compliance evaluations performed in block 1302. As noted herein, in certain aspects, determining the transmit power limit may include selecting the minimum allowed transmit power limit for each active radio out of the multiple time-averaged RF exposure compliance evaluations.

The workflow 1300 may also involve, at block 1306, sending the transmit power limit determined at block 1304 to transceiver circuitry. For example, the minimum allowed transmit power limit for each active radio out of the multiple time-averaged RF exposure compliance evaluations may be sent to transceiver circuitry (e.g., the transceiver depicted in FIG. 2) as the power limit for transmission.

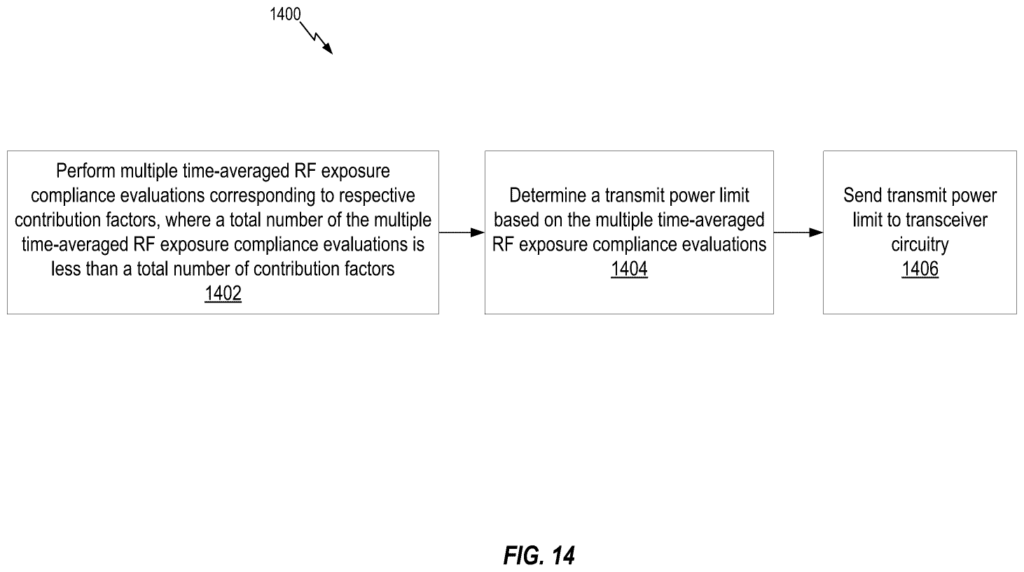

FIG. 14 illustrates an example workflow 1400 for another time-averaged RF exposure compliance evaluation based on RF exposure contribution information, according to certain aspects of the present disclosure. Compared to the workflow 1300, in workflow 1400, the number of time-averaged RF exposure compliance evaluations that are performed may be less than the number of contribution factors Cᵢⱼ. Here, for example, the time-averaged RF exposure compliance evaluation corresponding to the q^{th} contribution factor may not be performed (e.g., skipped).

As illustrated, the workflow 1400 may involve, at block 1402, performing multiple time-averaged RF exposure compliance evaluations corresponding to respective contribution factors (or contribution ratios) for the time-averaged RF exposure compliance evaluations, where a total number of the multiple time-averaged RF exposure compliance evaluations is less than a total number of the contribution factors Cᵢⱼ. For example, assuming there are m contribution factors, the total number of time-averaged RF exposure compliance evaluations that are performed may be less than m. In certain aspects, the time-averaged RF exposure compliance evaluation corresponding to the q^{th} contribution factor may not be performed (e.g., skipped). For example, determining which time-averaged RF exposure compliance evaluations to skip may involve determining which contribution factors are less than a threshold (C_{iq}=0 or less than a predetermined value), and determining to skip the time-averaged RF exposure compliance evaluation(s) (e.g., q^{th} time-averaged RF exposure compliance evaluation) corresponding to the contribution factor(s) less than the threshold.

In certain cases, each time-averaged RF exposure compliance evaluation performed in block 1402 may include: (i) determining a consumed exposure budget for a prior time interval of a time-averaging window based on the contribution factor Cᵢⱼ(e.g., consumed exposure budget=Cᵢⱼ*RF Tx power report/Pₗᵢₘᵢₜ); (ii) performing a time-averaging operation to determine an allowed exposure margin (or budget) for a future time interval of the time-averaging window; and (iii) determining an allowed transmit power limit based in part on the allowed exposure margin, where the allowed transmit power limit is boosted by the inverse of the contribution factor Cᵢⱼ(e.g., allowed transmit power limit=allowed exposure budget*Pₗᵢₘᵢₜ/Cᵢⱼ), resulting in a higher transmit power for the radio to transmit to obtain higher performance.

The workflow 1400 may also involve, at block 1404, determining a transmit power limit based on the multiple time-averaged RF exposure compliance evaluations performed in block 1402. As noted herein, in certain aspects, determining the transmit power limit may include selecting the minimum allowed transmit power limit for each active radio out of the multiple time-averaged RF exposure compliance evaluations.

The workflow 1400 may also involve, at block 1406, sending the transmit power limit determined at block 1404 to transceiver circuitry. For example, the minimum allowed transmit power limit for each active radio out of the multiple time-averaged RF exposure compliance evaluations may be sent to transceiver circuitry (e.g., the transceiver depicted in FIG. 2) as the power limit for transmission.

In certain aspects, performing a time-averaged RF exposure compliance evaluation for RF exposure compliance based on RF exposure contribution information may involve storing a worst (e.g., highest) exposure out of the m contribution factors and performing a single combined time-averaged RF exposure compliance evaluation based on RF exposure contribution information. In such aspects, the time-averaged RF exposure compliance evaluation may be represented with the following:

$$max \{ {\sum }_{i = 1}^{p} [ {\int }_{t - Ti}^{t - Δ t} \frac{1}{Ti} * \frac{Tx \cdot pwr \cdot radio \cdot i ( t )}{Plimit \cdot i} * [ {C}_{i 1} , {C}_{i 2} , … , {C}_{im} ] ] \} + {\sum }_{i = 1}^{p} [ \frac{1}{Ti} * \frac{Tx \cdot pwr \cdot radio \cdot i ( Δ t )}{Plimit \cdot i} * [ {C}_{i 1} , {C}_{i 2} , … , {C}_{im} ] ] \leq 1. \qquad ( 14 )$$

Here, as shown in Equation 14, a single time-averaged RF exposure compliance evaluation is performed to determine the i^{th} radio's allowable power to transmit (e.g., Tx.pwr.radio.i(Δt)) in a future time interval (e.g., Δt) of a time-averaging window, and a single (e.g., maximum) consumed exposure term (e.g.,

$$max \{ {\sum }_{i = 1}^{p} [ {\int }_{t - Ti}^{t - Δ t} \frac{1}{Ti} * \frac{Tx \cdot pwr \cdot radio \cdot i ( t )}{Plimit \cdot i} * [ {C}_{i 1} , {c}_{i 2} , … , {c}_{im} ] ] \}$$

) is stored in the exposure history.

In certain aspects, when performing a time-averaged RF exposure compliance evaluation according to Equation 14, if each of the p transmitting (or active) radios operates in the same time window, then the operating time-averaging window Ti may be the same for each of the p transmitting radios. In such aspects, the maximum consumed exposure term (e.g.,

$$max \{ {\sum }_{i = 1}^{p} [ {\int }_{t - Ti}^{t - Δ t} \frac{1}{Ti} * \frac{Tx \cdot pwr \cdot radio \cdot i ( t )}{Plimit \cdot i} * [ {C}_{i 1} , {c}_{i 2} , … , {c}_{im} ] ] \}$$

) every Δt seconds may be stored in the operating time-averaging window Ti, which may age out after Ti seconds during the time-averaging operation.

In certain aspects, when performing a time-averaged RF exposure compliance evaluation according to Equation 14, if one or more of the p transmitting radios operate in different time windows, then the maximum consumed exposure may be stored differently from the scenario in which each of the p transmitting radios operates in the same time window. By way of example, consider a scenario in which there are two active radios, radio A and radio C. In such a scenario, the time-averaged RF exposure compliance evaluation in Equation 14 for two active radios may be represented with the following:

$${\int }_{t - Tac}^{t - Δ t} max \{ \frac{1}{Ta} * \frac{Tx \cdot pwr \cdot radio \cdot a ( t )}{Plimit \cdot a} [ {C}_{a 1} , {C}_{a 2} , … , {C}_{am} ] + \frac{1}{Tc} * \frac{Tx \cdot pwr \cdot radio \cdot c ( t )}{Plimit \cdot c} * [ {C}_{c 1} , {C}_{c 2} , … , {C}_{cm} ] \} + \frac{1}{Ta} * \{ \frac{Tx \cdot pwr \cdot radio \cdot a ( Δ t )}{Plimit \cdot a} [ {C}_{a 1} , {C}_{a 2} , … , {C}_{am} ] \} + \frac{1}{Tc} * \{ \frac{Tx \cdot pwr \cdot radio \cdot c ( Δ t )}{Plimit \cdot c} * [ {C}_{c 1} , {C}_{c 2} , … , {C}_{cm} ] \} \leq 1. \qquad ( 15 )$$

where Ta is the operating time-averaging window for radio A, Tc is the operating time-averaging window for radio C, consumed exposure term

$$G = \frac{1}{Ta} * \frac{Tx \cdot pwr \cdot radio \cdot a ( t )}{Plimit \cdot a} * [ {C}_{a 1} , {C}_{a 2} , … , {C}_{am} ] ,$$

consumed exposure term

$$H = \frac{1}{Tc} * \frac{Tx \cdot pwr \cdot radio \cdot c ( t )}{Plimit \cdot c} * [ {C}_{c 1} , {C}_{c 2} , … , {C}_{cm} ] ,$$

and the maximum consumed exposure term

$$M 2 = max \{ \frac{1}{Ta} * \frac{Tx \cdot pwr \cdot radio \cdot a ( t )}{Plimit \cdot a} [ {C}_{a 1} , {C}_{a 2} , … , {C}_{am} ] + \frac{1}{Tc} * \frac{Tx \cdot pwr \cdot radio \cdot c ( t )}{Plimit \cdot c} * [ {C}_{c 1} , {C}_{c 2} , … , {C}_{cm} ] \} .$$

In an illustrative example, if Ta (e.g., 100 seconds) is greater than Tc (e.g., 60 seconds), then the consumed exposure term G should stay in the exposure history for a longer amount of time than the consumed exposure term H. In this example, while storing the maximum consumed exposure term M2 in a longer time window may ensure RF exposure compliance, such storage in a longer time window may result in lower performance for the wireless device, since the consumed exposure term H may last longer in the exposure history than the consumed exposure term H should. Similarly, while storing the maximum consumed exposure term M2 in a shorter time window may result in higher performance for the wireless device, such storage in a shorter time window may result in non-compliance with an RF exposure limit since the consumed exposure term G would age out faster in Tc seconds instead of lasting longer for Ta seconds.

To address this, certain aspects described herein may store the maximum of the consumed exposure term G (e.g., consumed exposure term M1) in the longer Ta window, and store the maximum consumed exposure term M2−the maximum of the consumed exposure term G (i.e., store M2−M1) in the shorter Tc window. Here, the consumed exposure term M1 may be represented with the following:

$$M 1 = \{ \frac{1}{Ta} * \frac{Tx \cdot pwr \cdot radio \cdot a ( t )}{Plimit \cdot a} * \{ Ca 1 , Ca 2 , … , Cam ] \} = \frac{1}{Ta} * \frac{Tx \cdot pwr \cdot radio \cdot a ( t )}{Plimit \cdot a} \qquad ( 16 )$$

Note, in certain aspects, the exposure history handling described herein may be extended to a 3 time window scenario in which T1>T2>T3. For example, if multiple radios (e.g., two radios in each time window) are active in 3 time windows, then the consumed exposure may be stored using consumed exposure terms M1, M2, and M3. M1 is a consumed exposure term for all radios in the largest time window (e.g., T1), M2 is a combined consumed exposure term for all radios in the largest 2 time windows (e.g., T1 and T2), and M3 is a total maximum consumed exposure term for all radios in the 3 time windows (e.g., T1, T2, and T3).

M1 may be represented using the following:

$$M 1 = \frac{1}{T 1} * max \{ \frac{Tx \cdot pwr \cdot radio \cdot 1 ( t )}{Plimit \cdot 1} * [ {C}_{11} , {C}_{12} , … , {C}_{1 m} ] + \frac{Tx \cdot pwr \cdot radio \cdot 2 ( t )}{Plimit \cdot 2} * [ {C}_{21} , {C}_{22} , … , {C}_{2 m} ] \} \qquad ( 17 )$$

M2 may be represented using the following:

$$M 2 = max \{ \frac{1}{T 1} * \frac{Tx \cdot pwr \cdot radio \cdot 1 ( t )}{Plimit \cdot 1} * [ {C}_{11} , {C}_{12} , … , {C}_{1 m} ] + \frac{1}{T 1} * \frac{Tx \cdot pwr \cdot radio \cdot 2 ( t )}{Plimit \cdot 2} * [ {C}_{21} , {C}_{22} , … , {C}_{2 m} ] + \frac{1}{T 2} * \frac{Tx \cdot pwr \cdot radio \cdot 3 ( t )}{Plimit \cdot 3} * [ {C}_{31} , {C}_{32} , … , {C}_{3 m} ] + \frac{1}{T 2} * \frac{Tx \cdot pwr \cdot radio \cdot 4 ( t )}{Plimit \cdot 4} * [ {C}_{41} , {C}_{42} , … , {C}_{4 m} ] \} \qquad ( 18 )$$

M3 may be represented using the following:

$$M 3 = max \{ \frac{1}{T 1} * \frac{Tx \cdot pwr \cdot radio \cdot 1 ( t )}{Plimit \cdot 1} * [ {C}_{11} , {C}_{12} , … , {C}_{1 m} ] + \frac{1}{T 1} * \frac{Tx \cdot pwr \cdot radio \cdot 2 ( t )}{Plimit \cdot 2} * [ {C}_{21} , {C}_{22} , … , {C}_{2 m} ] + \frac{1}{T 2} * \frac{Tx \cdot pwr \cdot radio \cdot 3 ( t )}{Plimit \cdot 3} * [ {C}_{31} , {C}_{32} , … , {C}_{3 m} ] + \frac{1}{T 2} * \frac{Tx \cdot pwr \cdot radio \cdot 4 ( t )}{Plimit \cdot 4} * [ {C}_{41} , {C}_{42} , … , {C}_{4 m} ] + \frac{1}{T 3} * \frac{Tx \cdot pwr \cdot radio \cdot 5 ( t )}{Plimit \cdot 5} * [ {C}_{51} , {C}_{52} , … , {C}_{5 m} ] + \frac{1}{T 3} * \frac{Tx \cdot pwr \cdot radio \cdot 6 ( t )}{Plimit \cdot 6} * [ {C}_{61} , {C}_{62} , … , {C}_{6 m} ] \} \qquad ( 19 )$$

Certain aspects described herein may store the consumed exposure term M1 in the longest T1 window, store the difference in exposure terms (M2−M1) in the second longest T2 window, and store the difference in exposure terms (M3−M2) in the smallest T3 window. This approach can be applied to any number of time windows by following the same steps of determining the terms M1, M2, M3, M4, . . . , etc., and determining the difference terms (M1−0), (M2−M1), (M3−M2), (M4−M3), . . . , etc., to store in respective time windows T1, T2, T3, T4, . . . , etc.

In certain aspects, performing the time-averaged RF exposure compliance according to Equation 14 may provide a higher transmit power for the i^{th} radio, resulting in higher performance for the i^{th} radio compared to the performance for the i^{th} radio without the RF exposure contribution information. For example, the time-averaged RF exposure compliance in Equation 14 may leverage the contribution factors when summing up consumed exposure from multiple contribution factors (e.g.,

$$max \{ {\sum }_{i = 1}^{p} [ {\int }_{t - Ti}^{t - Δ t} \frac{1}{Ti} * \frac{Tx \cdot pwr \cdot radio \cdot i ( t )}{Plimit \cdot i} * [ {C}_{i 1} , {C}_{i 2} , … , {C}_{im} ] ] \} \leq {\sum }_{i = 1}^{p} [ {\int }_{t - Ti}^{t - Δ t} \{ \frac{1}{Ti} * \frac{Tx \cdot pwr \cdot radio \cdot i ( t )}{Plimit \cdot i} \} ]$$

), such that the time-averaged consumed exposure is lower (compared to the time-averaged consumed exposure without contribution factors), resulting in more available margin for the future transmission (e.g., allowed transmit power limit).

Additionally, in certain aspects, the allowed transmit power limit determined using Equation 14 may be boosted. For example, since the allowed exposure budget for the future transmission is multiplied by Cᵢⱼ when determining the consumed exposure for the time-averaged RF exposure compliance evaluation, the allowed exposure budgets can be boosted by a boost factor Bi according to the following:

$$max \{ {\sum }_{i = 1}^{p} [ Bi * \frac{1}{Ti} * \frac{Tx \cdot pwr \cdot radio \cdot i ( t )}{Plimit \cdot i} * [ {C}_{i 1} , {C}_{i 2} , … , {C}_{im} ] ] \} = {\sum }_{i = 1}^{p} [ \frac{1}{Ti} * \frac{Tx \cdot pwr \cdot radio \cdot i ( Δ t )}{Plimit \cdot i} ] \qquad ( 20 )$$

where each Bi>1 for all p active radios.

In certain aspects, for Equation 20, the boost factor Bi may be equal for all radios. In such aspects, Bi may be represented using the following:

$$B = Bi = \frac{{\sum }_{i = 1}^{p} [ \frac{1}{Ti} * \frac{Tx \cdot pwr \cdot radio \cdot i ( Δ t )}{Plimit \cdot i} ]}{\begin{matrix}max \{ {\sum }_{i = 1}^{p} [ Bi * \frac{1}{Ti} * \\ \frac{Tx \cdot pwr \cdot radio \cdot i ( t )}{Plimit \cdot i} * [ {C}_{i 1} , {C}_{i 2} , … , {C}_{im} ] ] \}\end{matrix}} \qquad ( 21 )$$

Note, however, in certain other aspects, the boost factor Bi may be unequal among the p active radios. In such aspects, determining the boost factor Bi for the i^{th} radio may involve iteratively solving Equations 20/21.

In certain aspects, for the time-averaged RF exposure compliance in Equation 14, since the maximum of total exposure out of all radios after applying contribution factors is stored in exposure history for each Δt instance, this approach may provide a worst-case time-averaged exposure assessment in scenarios where human tissue is moving relative to the wireless device over time and this movement is unknown. As an example, in a 2 antenna group scenario when an antenna transmitting out of a first antenna group consumes 100% of exposure margin in half of the time-window and switches to a second antenna group to transmit 100% of exposure margin in another half of the time-window, each antenna group may be compliant with an RF exposure limit. However, when the transmitting antenna switches from the first antenna group to the second antenna group, if exposed human tissue in the first antenna group moves relative to the wireless device to align with the second antenna group's hotspot at a same time that the antenna switched, then the same human tissue may get exposed twice. In such scenarios, performing the time-averaged RF exposure compliance evaluation according to Equation 14 may ensure that the wireless device remains compliant with an RF exposure limit (e.g., the time-averaged RF exposure compliance evaluation in Equation 14 may assume the exposure hotspot is in the same location before and after the antenna switch).

### Example Operations for Wireless Communications

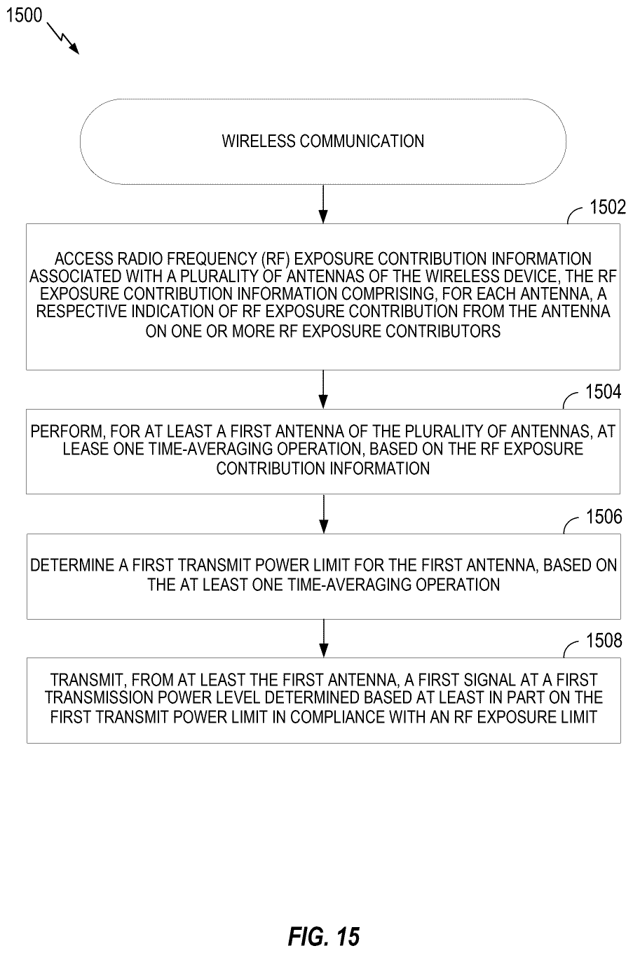

FIG. 15 is a flow diagram illustrating example operations 1500 for wireless communication. The operations 1500 may be performed, for example, by a wireless device (e.g., the wireless device 102 in the wireless communication system 100) and/or a processing system. The operations 1500 may be implemented as software components that are executed and run on one or more processors (e.g., the processor 210 and/or the modem 212 of FIG. 2).

The operations 1500 may involve, at block 1502, accessing radio frequency (RF) exposure contribution information associated with a plurality of antennas of the wireless device. The RF exposure contribution information may include, for each antenna, a respective indication of RF exposure contribution from the antenna on one or more RF exposure contributors. In certain aspects, the RF exposure contribution information includes a contribution matrix (see FIG. 12). In certain aspects, the RF exposure contribution information (e.g., contribution matrix 1200) may be generated using the iterative contour approach described herein. In some cases, each contribution factor may be representative of a highest level of interaction of another antenna on the antenna(s) for the i^{th} radio, resulting in m=N antennas or in certain aspects, the contribution matrix 1200 may be a square matrix. In some cases, each contribution factor may be representative of a highest level of interaction of a region of an RF exposure distribution (or map) associated with the wireless device on the antenna(s) for the i^{th} radio, resulting in m=m regions. In some cases, each contributor factor may be representative of a highest level of interaction of a surface of the wireless device on the antenna(s) for the i^{th} radio, resulting in m=# of surfaces.

The operations 1500 may also involve, at block 1504, performing, for at least a first antenna of the plurality of antennas, at least one time-averaging operation, based on the RF exposure contribution information.

The operations 1500 may also involve, at block 1506, determining a first transmit power limit for the first antenna, based on the at least one time-averaging operation.

The operations 1500 may further involve, at block 1508, transmitting, from at least the first antenna, a first signal at a first transmission power level determined based at least in part on the first transmit power limit in compliance with an RF exposure limit.

In certain aspects, for each antenna, the indications of RF exposure contributions may include a contribution matrix. The contribution matrix may include a respective contribution factor representative of a highest level of interaction of an RF exposure distribution for the antenna with an RF exposure distribution for one of the one or more RF exposure contributors. In certain aspects, the one or more RF exposure contributors include each other antenna of the plurality of antennas (e.g., the contribution matrix is a N×m matrix, where m=N antennas). In certain aspects, the one or more RF exposure contributors include one or more regions of the RF exposure distribution for the one or more RF exposure contributors (e.g., the contribution matrix is a N×m matrix, where m=m regions). In certain aspects, the one or more RF exposure contributors include one or more surfaces of the wireless device (e.g., the contribution matrix is a N×m matrix, where m=# of surfaces).

In certain aspects, the indications of RF exposure contributions may be further associated with a transmit scenario supported by the wireless device. The transmit scenario may include a respective one or more radios, a respective antenna grouping, a respective transmit frequency band, a respective RF exposure scenario, a respective state of the wireless device, a respective device application use-case, a respective geographical location or region, or any combination thereof.

In certain aspects, performing the at least one time-averaging operation may include: (i) performing, for the first antenna, a respective time-averaging operation for each contribution factor within the respective contribution matrix for the first antenna; (ii) determining, for each time-averaging operation, a respective second transmit power limit for the first antenna; and (iii) selecting one of the second transmit power limits that satisfies a predetermined condition as the first transmit power limit. In such aspects, the predetermined condition may include the one of the second transmit power limits having a lowest value among the second transmit power limits.

In certain aspects, performing the at least one time-averaging operation may further include determining, for each time-averaging operation, a respective boost factor for the first antenna based on the respective contribution factor. In such aspects, each second transmit power limit for the first antenna may be further determined based on the respective boost factor.

In certain aspects, performing the at least one time-averaging operation may include: (i) determining a subset of contribution factors within the respective contribution matrix for the first antenna that satisfies a predetermined condition; (ii) performing, for the first antenna, a respective time-averaging operation for each contribution factor within the subset of contribution factors; (iii) determining, for each time-averaging operation, a respective second transmit power limit for the first antenna; and (iii) selecting one of the second transmit power limits having a lowest value among the second transmit power limits as the first transmit power limit. In such aspects, the predetermined condition may include a value of the contribution factor being below a threshold.

In certain aspects, performing the at least one time-averaging operation may include: (i) performing, for the first antenna, a single time-averaging operation based on the contribution factors within the respective contribution matrix for the first antenna; (ii) determining, based on the single time-averaging operation for the first antenna, a second transmit power limit for the first antenna; and (iii) using the second transmit power limit as the first transmit power limit.

In certain aspects, the operations 1500 may further involve: (i) performing, for at least a second antenna of the plurality of antennas, a single time-averaging operation, based on the contribution factors within the respective contribution matrix for the second antenna; (ii) determining, based on the single time-averaging operation for the second antenna, a third transmit power limit for the second antenna; and (iii) transmitting, from at least the second antenna, a second signal at a second transmission power level determined based at least in part on the third transmit power limit in compliance with the RF exposure limit.

In certain aspects, the RF exposure limit is a time-averaged RF exposure limit.

In certain aspects, the first signal and the second signal may be transmitted during a first time interval within a time window associated with the time-averaged RF exposure limit. In such aspects, the operations 1500 may further involve: (i) determining an amount of consumed exposure during a second time interval, prior to the first time interval, within the time window based at least in part on the first transmission power level, the second transmission power level, the contribution factors within the respective contribution matrix for the first antenna, and the contribution factors within the respective contribution matrix for the second antenna; and (ii) storing an indication of the amount of consumed exposure. Additionally, in such aspects, determining the amount of consumed exposure may include: determining a first consumed exposure parameter based on the first transmission power level and the contribution factors within the respective contribution matrix for the first antenna; and determining a second consumed exposure parameter based on the second transmission power level and the contribution factors within the respective contribution matrix for the second antenna. Storing the indication of the amount of consumed exposure may include storing a maximum of the first consumed exposure parameter and the second consumed exposure parameter.

In certain aspects, the first signal may be transmitted during a first time interval within a first time window associated with the time-averaged RF exposure limit and the second signal may be transmitted during a first time interval within a second time window associated with the time-averaged RF exposure limit. In such aspects, the operations 1500 may further involve: (i) determining a first consumed exposure parameter for a second time interval, prior to the first time interval, of the first time window based on the first transmission power level and the contribution factors within the respective contribution matrix for the first antenna; (ii) determining a second consumed exposure parameter for a second time interval, prior to the first time interval, of the second time window based on the second transmission power level and the contribution factors within the respective contribution matrix for the second antenna; and (iii) storing the first consumed exposure parameter for a longer duration than the second consumed exposure parameter. The first time window may be longer than the second time window.

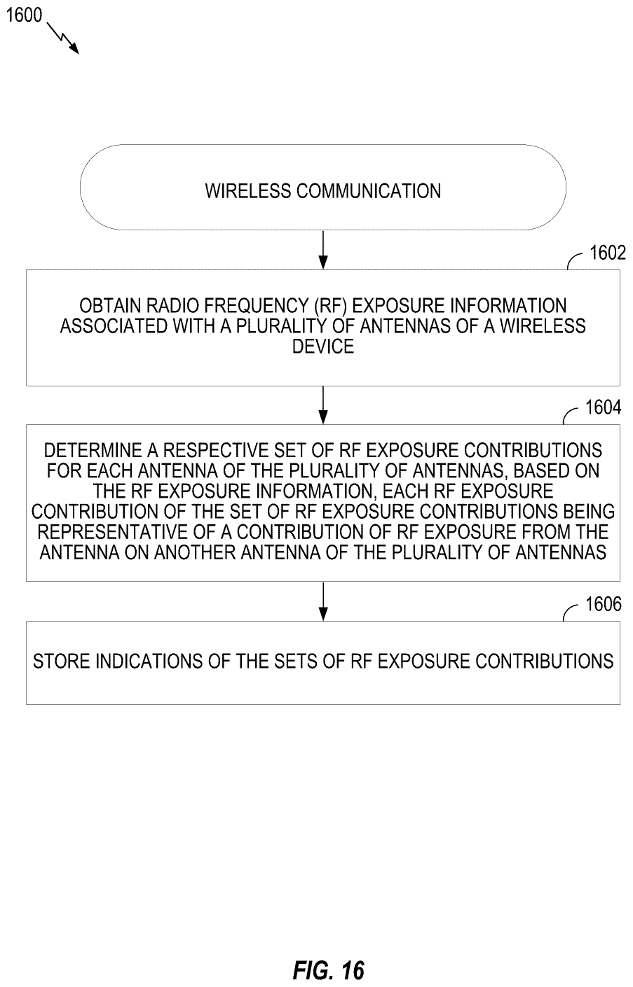

FIG. 16 is a flow diagram illustrating example operations 1600 for wireless communication. The operations 1600 may be performed, for example, by a wireless device (e.g., the wireless device 102 in the wireless communication system 100) and/or a processing system. The operations 1600 may be implemented as software components that are executed and run on one or more processors (e.g., the processor 210 and/or the modem 212 of FIG. 2).

The operations 1600 may involve, at block 1602, obtaining radio frequency (RF) exposure information associated with a plurality of antennas of a wireless device.

The operations 1600 may also involve, at block 1604, determining a respective set of RF exposure contributions for each antenna of the plurality of antennas, based on the RF exposure information. Each RF exposure contribution of the set of RF exposure contributions may be representative of a contribution of RF exposure from the antenna on another antenna of the plurality of antennas.

The operations 1600 may further involve, at block 1606, storing indications of the sets of RF exposure contributions.

In certain aspects, the RF exposure information may include a respective one or more RF exposure distributions for each antenna of the plurality of antennas, each RF exposure distribution being associated with a different transmit scenario supported by the wireless device. In some cases, the RF exposure information includes, for each antenna, a single composite map of the respective one or more RF exposure distributions for the antenna. In certain aspects, each RF exposure distribution may be representative of RF exposure from the antenna across a plurality of surfaces of the wireless device.

In certain aspects, at least one of the one or more RF exposure distributions for at least one of the antennas may include an indication of a first contour level of RF exposure from the at least one of the antennas. In such aspects, obtaining the RF exposure information may further include assuming one or more second contour levels of RF exposure from the at least one of the antennas has a same amplitude as the first contour level.

In certain aspects, for each RF exposure contribution of the set of RF exposure contributions for each antenna, determining the RF exposure contribution may include: (i) overlapping at least one of the one or more RF exposure distributions for the antenna with the RF exposure distribution with another antenna of the plurality of antennas; and (ii) determining an amount of interaction between the RF exposure distributions for the antennas, based on the overlapping.

In certain aspects, determining the amount of interaction may include determining, for each of one or more contour levels of the at least one RF exposure distribution for the antenna, a level of interaction of the contour level with a contour level of the RF exposure distribution for the other antenna.

In certain aspects, the contour level of the RF exposure distribution for the other antenna is a highest contour level of the RF exposure distribution for the other antenna that interacts with the contour level of the at least one RF exposure distribution for the antenna.

In certain aspects, the highest contour level of the RF exposure distribution for the other antenna is less than the contour level of the at least one RF exposure distribution for the antenna.

In certain aspects, the operations 1600 may further involve generating a contribution matrix comprising, for each antenna of the plurality of antennas, a contribution factor representative of a highest level of interaction of the one or more contour levels of the at least one RF exposure distribution for the antenna with the RF exposure distribution for the other antenna. In such aspects, storing the indications of the sets of RF exposure contributions may include storing the contribution matrix.

### Example Communications Device

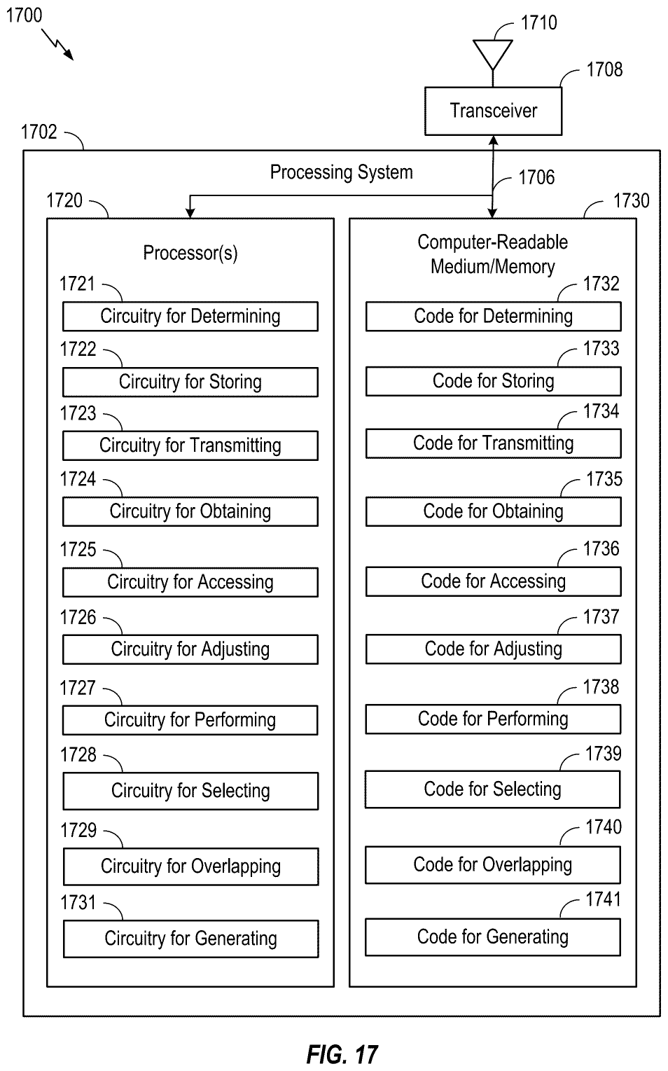

FIG. 17 depicts aspects of an example communications device 1700. In some aspects, communications device 1700 is a wireless communication device, such as the wireless device 102 described above with respect to FIGS. 1 and 2.

The communications device 1700 includes a processing system 1702 coupled to a transceiver 1708 (e.g., a transmitter and/or a receiver). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes one or more processors 1720. In various aspects, the one or more processors 1720 may be representative of any of the processor 210 and/or the modem 212, as described with respect to FIG. 2. The one or more processors 1720 are coupled to a computer-readable medium/memory 1730 via a bus 1706. In certain aspects, the computer-readable medium/memory 1730 is configured to store instructions (e.g., computer-executable code) that when executed by the one or more processors 1720, cause the one or more processors 1720 to perform the operations 1500 described with respect to FIG. 15, the operations 1600 described with respect to FIG. 16, or any aspect related to the operations described herein. Note that reference to a processor performing a function of communications device 1700 may include one or more processors performing that function of communications device 1700.

In the depicted example, computer-readable medium/memory 1730 stores code (e.g., executable instructions) for determining 1732, code for storing 1733, code for transmitting 1734, code for obtaining 1735, code for accessing 1736, code for adjusting 1737, code for performing 1738, code for selecting 1739, code for overlapping 1740, and code for generating (including regenerating) 1741. Processing of the code 1732-1741 may cause the communications device 1700 to perform the operations 1500 described with respect to FIG. 15, the operations 1600 described with respect to FIG. 16, or any aspect related to operations described herein.

The one or more processors 1720 include circuitry configured to implement (e.g., execute) the code stored in the computer-readable medium/memory 1730, including circuitry for determining (including selecting) 1721, circuitry for storing 1722, circuitry for transmitting 1723, circuitry for obtaining 1724, circuitry for accessing 1725, circuitry for adjusting 1726, circuitry for performing 1727, circuitry for selecting 1728, circuitry for overlapping 1729, and circuitry for generating (including regenerating) 1731. Processing with circuitry 1721-1731 may cause the communications device 1700 to perform the operations 1500 described with respect to FIG. 15, the operations 1600 described with respect to FIG. 16, or any aspect related to operations described herein.

Various components of the communications device 1700 may provide means for performing the operations 1500 described with respect to FIG. 15, the operations 1600 described with respect to FIG. 16, or any aspect related to operations described herein. For example, means for transmitting, sending, or outputting for transmission may include the TX path 214 and/or antenna(s) 218 of the wireless device 102 illustrated in FIG. 2 and/or transceiver 1708 and antenna 1710 of the communications device 1700 in FIG. 17. Means for receiving or obtaining may include the RX path 216 and/or antenna(s) 218 of the wireless device 102 illustrated in FIG. 2, and/or transceiver 1708 and antenna 1710 of the communications device 1700 in FIG. 17. Means for controlling, means for performing, means for operating, means for overlapping, means for accessing, means for refraining, means for determining, means for detecting, means for storing, means for accessing, means for adjusting, means for (re)generating, means for using, means for obtaining, and/or means for providing may include a processor, such as the processor 210 and/or modem 212 depicted in FIG. 2 and/or the processor(s) 1720 in FIG. 17.

### EXAMPLE ASPECTS

Implementation examples are described in the following numbered clauses:

Aspect 1: A method of wireless communication by a wireless device, comprising: accessing radio frequency (RF) exposure contribution information associated with a plurality of antennas of the wireless device, the RF exposure contribution information comprising, for each antenna, a respective indication of RF exposure contribution from the antenna on one or more RF exposure contributors; performing, for at least a first antenna of the plurality of antennas, at least one time-averaging operation, based on the RF exposure contribution information; determining a first transmit power limit for the first antenna, based on the at least one time-averaging operation; and transmitting, from at least the first antenna, a first signal at a first transmission power level determined based at least in part on the first transmit power limit in compliance with an RF exposure limit.

Aspect 2: The method of Aspect 1, wherein, for each antenna, the indications of RF exposure contributions comprise a contribution matrix, the contribution matrix comprising a respective contribution factor representative of a highest level of interaction of an RF exposure distribution for the antenna with an RF exposure distribution for one of the one or more RF exposure contributors.

Aspect 3: The method of any of Aspects 1-2, wherein: the indications of RF exposure contributions are further associated with a transmit scenario supported by the wireless device; and the transmit scenario comprises a respective one or more radios, a respective antenna grouping, a respective transmit frequency band, a respective RF exposure scenario, a respective state of the wireless device, a respective device application use-case, a respective geographical location or region, or any combination thereof.

Aspect 4: The method of any of Aspects 2-3, wherein the one or more RF exposure contributors comprise each other antenna of the plurality of antennas.

Aspect 5: The method of any of Aspects 2-3, wherein the one or more RF exposure contributors comprise one or more regions of the RF exposure distribution for the one or more RF exposure contributors.

Aspect 6: The method of any of Aspects 2-3, wherein the one or more RF exposure contributors comprise one or more surfaces of the wireless device.

Aspect 7: The method of any of Aspects 2-6, wherein performing the at least one time-averaging operation comprises: performing, for the first antenna, a respective time-averaging operation for each contribution factor within the respective contribution matrix for the first antenna; determining, for each time-averaging operation, a respective second transmit power limit for the first antenna; and selecting one of the second transmit power limits that satisfies a predetermined condition as the first transmit power limit.

Aspect 8: The method of Aspect 7, wherein the predetermined condition comprises the one of the second transmit power limits having a lowest value among the second transmit power limits.

Aspect 9: The method of any of Aspects 7-8, wherein: performing the at least one time-averaging operation further comprises determining, for each time-averaging operation, a respective boost factor for the first antenna based on the respective contribution factor; and each second transmit power limit for the first antenna is further determined based on the respective boost factor.

Aspect 10: The method of any of Aspects 2-6, wherein performing the at least one time-averaging operation comprises: determining a subset of contribution factors within the respective contribution matrix for the first antenna that satisfies a predetermined condition; performing, for the first antenna, a respective time-averaging operation for each contribution factor within the subset of contribution factors; determining, for each time-averaging operation, a respective second transmit power limit for the first antenna; and selecting one of the second transmit power limits having a lowest value among the second transmit power limits as the first transmit power limit.

Aspect 11: The method of Aspect 10, wherein the predetermined condition comprises a value of the contribution factor being below a threshold.

Aspect 12: The method of any of Aspects 2-6, wherein performing the at least one time-averaging operation comprises: performing, for the first antenna, a single time-averaging operation based on the contribution factors within the respective contribution matrix for the first antenna; determining, based on the single time-averaging operation for the first antenna, a second transmit power limit for the first antenna; and using the second transmit power limit as the first transmit power limit.

Aspect 13: The method of any of Aspects 2-6 and 12, further comprising: performing, for at least a second antenna of the plurality of antennas, a single time-averaging operation based on the contribution factors within the respective contribution matrix for the second antenna; determining, based on the single time-averaging operation for the second antenna, a third transmit power limit for the second antenna; and transmitting, from at least the second antenna, a second signal at a second transmission power level determined based at least in part on the third transmit power limit in compliance with the RF exposure limit.

Aspect 14: The method of Aspect 13, wherein the RF exposure limit is a time-averaged RF exposure limit.

Aspect 15: The method of Aspect 14, wherein the first signal and the second signal are transmitted during a first time interval within a time window associated with the time-averaged RF exposure limit, the method further comprising: determining an amount of consumed exposure during a second time interval, prior to the first time interval, within the time window based at least in part on the first transmission power level, the second transmission power level, the contribution factors within the respective contribution matrix for the first antenna, and the contribution factors within the respective contribution matrix for the second antenna; and storing an indication of the amount of consumed exposure.

Aspect 16: The method of Aspect 15, wherein: determining the amount of consumed exposure comprises: determining a first consumed exposure parameter based on the first transmission power level and the contribution factors within the respective contribution matrix for the first antenna; and determining a second consumed exposure parameter based on the second transmission power level and the contribution factors within the respective contribution matrix for the second antenna; and storing the indication of the amount of consumed exposure comprises storing a maximum of the first consumed exposure parameter and the second consumed exposure parameter.

Aspect 17: The method of Aspect 14, wherein the first signal is transmitted during a first time interval within a first time window associated with the time-averaged RF exposure limit and wherein the second signal is transmitted during a first time interval within a second time window associated with the time-averaged RF exposure limit, the method further comprising: determining a first consumed exposure parameter for a second time interval, prior to the first time interval, of the first time window based on the first transmission power level and the contribution factors within the respective contribution matrix for the first antenna; determining a second consumed exposure parameter for a second time interval, prior to the first time interval, of the second time window based on the second transmission power level and the contribution factors within the respective contribution matrix for the second antenna; and storing the first consumed exposure parameter for a longer duration than the second consumed exposure parameter.

Aspect 18: The method of Aspect 17, wherein the first time window is longer than the second time window.

Aspect 19: A method of wireless communication, comprising: obtaining radio frequency (RF) exposure information associated with a plurality of antennas of a wireless device; determining a respective set of RF exposure contributions for each antenna of the plurality of antennas, based on the RF exposure information, each RF exposure contribution of the set of RF exposure contributions being representative of a contribution of RF exposure from the antenna on another antenna of the plurality of antennas; and storing indications of the sets of RF exposure contributions.

Aspect 20: The method of Aspect 19, wherein the RF exposure information comprises a respective one or more RF exposure distributions for each antenna of the plurality of antennas, each RF exposure distribution being associated with a different transmit scenario supported by the wireless device.

Aspect 21: The method of Aspect 20, wherein: at least one of the one or more RF exposure distributions for at least one of the plurality of antennas comprises an indication of a first contour level of RF exposure from the at least one of the antennas; and obtaining the RF exposure information further comprises assuming one or more second contour levels of RF exposure from the at least one of the antennas has a same amplitude as the first contour level.

Aspect 22: The method of any of Aspects 20-21, wherein the RF exposure information comprises, for each antenna, a single composite map of the respective one or more RF exposure distributions for the antenna.

Aspect 23: The method of any of Aspects 20-22, wherein each transmit scenario comprises a respective one or more radios, a respective antenna grouping, a respective transmit frequency band, a respective RF exposure scenario, a respective state of the wireless device, a respective device application use-case, a respective geographical location or region, or any combination thereof.

Aspect 24: The method of any of Aspects 20-23, wherein each RF exposure distribution is representative of RF exposure from the antenna across a plurality of surfaces of the wireless device.

Aspect 25: The method of any of Aspects 20-24, wherein, for each RF exposure contribution of the set of RF exposure contributions for each antenna, determining the RF exposure contribution comprises: overlapping at least one of the one or more RF exposure distributions for the antenna with the RF exposure distribution with another antenna of the plurality of antennas; and determining an amount of interaction between the RF exposure distributions for the antennas, based on the overlapping.

Aspect 26: The method of Aspect 25, wherein determining the amount of interaction comprises determining, for each of one or more contour levels of the at least one RF exposure distribution for the antenna, a level of interaction of the contour level with a contour level of the RF exposure distribution for the other antenna.

Aspect 27: The method of Aspect 26, wherein the contour level of the RF exposure distribution for the other antenna is a highest contour level of the RF exposure distribution for the other antenna that interacts with the contour level of the at least one RF exposure distribution for the antenna.

Aspect 28: The method of Aspect 27, wherein the highest contour level of the RF exposure distribution for the other antenna is less than the contour level of the at least one RF exposure distribution for the antenna.

Aspect 29: The method of any of Aspects 26-28, further comprising generating a contribution matrix comprising, for each antenna of the plurality of antennas, a contribution factor representative of a highest level of interaction of the one or more contour levels of the at least one RF exposure distribution for the antenna with the RF exposure distribution for the other antenna.

Aspect 30: The method of Aspect 29, wherein storing the indications of the sets of RF exposure contributions comprises storing the contribution matrix.

Aspect 31: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-30.

Aspect 32: An apparatus, comprising means for performing a method in accordance with any of Aspects 1-30.

Aspect 33: A non-transitory computer-readable medium comprising computer-executable instructions that, when executed by one or more processors of a processing system, cause the processing system to perform a method in accordance with any of Aspects 1-30.

Aspect 34: A computer program product embodied on a computer-readable storage medium comprising code for performing a method in accordance with any of Aspects 1-30.

### ADDITIONAL CONSIDERATIONS

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 15 and 16).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
accessing radio frequency (RF) exposure contribution information associated with a plurality of antennas of the wireless device, the RF exposure contribution information comprising, for each antenna, a respective indication of RF exposure contribution from the antenna on one or more RF exposure contributors;
performing, for at least a first antenna of the plurality of antennas, at least one time-averaging operation, based on the RF exposure contribution information;
determining a first transmit power limit for the first antenna, based on the at least one time-averaging operation; and
transmitting, from at least the first antenna, a first signal at a first transmission power level determined based at least in part on the first transmit power limit in compliance with an RF exposure limit.

2. The method of claim 1, wherein, for each antenna, the indications of RF exposure contributions comprise a contribution matrix, the contribution matrix comprising a respective contribution factor representative of a highest level of interaction of an RF exposure distribution for the antenna with an RF exposure distribution for one of the one or more RF exposure contributors.

3. The method of claim 2, wherein:
the indications of RF exposure contributions are further associated with a transmit scenario supported by the wireless device; and
the transmit scenario comprises a respective one or more radios, a respective antenna grouping, a respective transmit frequency band, a respective RF exposure scenario, a respective state of the wireless device, a respective device application use-case, a respective geographical location or region, or any combination thereof.

4. The method of claim 2, wherein the one or more RF exposure contributors comprise each other antenna of the plurality of antennas.

5. The method of claim 2, wherein the one or more RF exposure contributors comprise one or more regions of the RF exposure distribution for the one or more RF exposure contributors.

6. The method of claim 2, wherein the one or more RF exposure contributors comprise one or more surfaces of the wireless device.

7. The method of claim 2, wherein performing the at least one time-averaging operation comprises:
performing, for the first antenna, a respective time-averaging operation for each contribution factor within the respective contribution matrix for the first antenna;
determining, for each time-averaging operation, a respective second transmit power limit for the first antenna; and
selecting one of the second transmit power limits that satisfies a predetermined condition as the first transmit power limit.

8. The method of claim 7, wherein the predetermined condition comprises the one of the second transmit power limits having a lowest value among the second transmit power limits.

9. The method of claim 7, wherein:
performing the at least one time-averaging operation further comprises determining, for each time-averaging operation, a respective boost factor for the first antenna based on the respective contribution factor; and
each second transmit power limit for the first antenna is further determined based on the respective boost factor.

10. The method of claim 2, wherein performing the at least one time-averaging operation comprises:
determining a subset of contribution factors within the respective contribution matrix for the first antenna that satisfies a predetermined condition;
performing, for the first antenna, a respective time-averaging operation for each contribution factor within the subset of contribution factors;
determining, for each time-averaging operation, a respective second transmit power limit for the first antenna; and
selecting one of the second transmit power limits having a lowest value among the second transmit power limits as the first transmit power limit.

11. The method of claim 10, wherein the predetermined condition comprises a value of the contribution factor being below a threshold.

12. The method of claim 2, wherein performing the at least one time-averaging operation comprises:
performing, for the first antenna, a single time-averaging operation based on the contribution factors within the respective contribution matrix for the first antenna;
determining, based on the single time-averaging operation for the first antenna, a second transmit power limit for the first antenna; and
using the second transmit power limit as the first transmit power limit.

13. The method of claim 12, further comprising:
performing, for at least a second antenna of the plurality of antennas, a single time-averaging operation based on the contribution factors within the respective contribution matrix for the second antenna;
determining, based on the single time-averaging operation for the second antenna, a third transmit power limit for the second antenna; and
transmitting, from at least the second antenna, a second signal at a second transmission power level determined based at least in part on the third transmit power limit in compliance with the RF exposure limit.

14. The method of claim 13, wherein the RF exposure limit is a time-averaged RF exposure limit.

15. The method of claim 14, wherein the first signal and the second signal are transmitted during a first time interval within a time window associated with the time-averaged RF exposure limit, the method further comprising:
determining an amount of consumed exposure during a second time interval, prior to the first time interval, within the time window based at least in part on the first transmission power level, the second transmission power level, the contribution factors within the respective contribution matrix for the first antenna, and the contribution factors within the respective contribution matrix for the second antenna; and
storing an indication of the amount of consumed exposure.

16. The method of claim 15, wherein:
determining the amount of consumed exposure comprises:
determining a first consumed exposure parameter based on the first transmission power level and the contribution factors within the respective contribution matrix for the first antenna; and
determining a second consumed exposure parameter based on the second transmission power level and the contribution factors within the respective contribution matrix for the second antenna; and
storing the indication of the amount of consumed exposure comprises storing a maximum of the first consumed exposure parameter and the second consumed exposure parameter.

17. The method of claim 14, wherein the first signal is transmitted during a first time interval within a first time window associated with the time-averaged RF exposure limit and wherein the second signal is transmitted during a first time interval within a second time window associated with the time-averaged RF exposure limit, the method further comprising:
determining a first consumed exposure parameter for a second time interval, prior to the first time interval, of the first time window based on the first transmission power level and the contribution factors within the respective contribution matrix for the first antenna;
determining a second consumed exposure parameter for a second time interval, prior to the first time interval, of the second time window based on the second transmission power level and the contribution factors within the respective contribution matrix for the second antenna; and
storing the first consumed exposure parameter for a longer duration than the second consumed exposure parameter.

18. The method of claim 17, wherein the first time window is longer than the second time window.

19. An apparatus for wireless communication, comprising:
one or more memories collectively storing executable instructions; and
one or more processors coupled to the one or more memories, the one or more processors being collectively configured to execute the executable instructions to cause the apparatus to:
access radio frequency (RF) exposure contribution information associated with a plurality of antennas of the apparatus, the RF exposure contribution information comprising, for each antenna, a respective indication of RF exposure contribution from the antenna on one or more RF exposure contributors;
perform, for at least a first antenna of the plurality of antennas, at least one time-averaging operation, based on the RF exposure contribution information;
determine a first transmit power limit for the first antenna, based on the at least one time-averaging operation; and
transmit, from at least the first antenna, a first signal at a first transmission power level determined based at least in part on the first transmit power limit in compliance with an RF exposure limit.

20. An apparatus for wireless communication, comprising:
means for accessing radio frequency (RF) exposure contribution information associated with a plurality of antennas of the apparatus, the RF exposure contribution information comprising, for each antenna, a respective indication of RF exposure contribution from the antenna on one or more RF exposure contributors;
means for performing, for at least a first antenna of the plurality of antennas, at least one time-averaging operation, based on the RF exposure contribution information;
means for determining a first transmit power limit for the first antenna, based on the at least one time-averaging operation; and
means for transmitting, from at least the first antenna, a first signal at a first transmission power level determined based at least in part on the first transmit power limit in compliance with an RF exposure limit.
